(19) United States
(12) Patent Application Publication
(10) Pub. No.: US 2025/0261274 A1
(43) Pub. Date: Aug. 14, 2025

(54) Cell Discontinuous Transmission and Reception Control for Multiple Transmission Reception Points

(71) Applicant: QUALCOMM Incorporated, San Diego, CA (US)

(72) Inventors: Hung Dinh LY, San Diego, CA (US); Ahmed Attia ABOTABL, San Diego, CA (US)

(21) Appl. No.: 18/441,979

(22) Filed: Feb. 14, 2024

(51) Int. Cl. H04W 76/28; H04W 72/232; H04W 76/10; H04W 76/25

(52) U.S. Cl. CPC H04W 76/28; H04W 72/232; H04W 76/10; H04W 76/25

(57) ABSTRACT

Certain aspects of the present disclosure provide techniques for controlling cell discontinuous transmission (DTX) and cell discontinuous reception (DRX). A method performed by an apparatus generally includes maintaining a connection with a plurality of transmission reception points (TRPs) of at least one serving cell of the apparatus, receiving an indication associated with the plurality of TRPs indicating to change an activation state for at least one of cell DTX or cell DRX for at least one of the plurality of TRPs, and based at least in part on the indication, changing the activation state for at least one of the cell DTX or the cell DRX for the at least one of the plurality of TRPs.

### INTRODUCTION

### Field of the Disclosure

Aspects of the present disclosure relate to wireless communications, and more particularly, to techniques for controlling cell discontinuous transmission (DTX) and cell discontinuous reception (DRX).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes maintaining a connection with a plurality of transmission reception points (TRPs) of at least one serving cell of the apparatus; receiving an indication associated with the plurality of TRPs indicating to change an activation state for at least one of cell discontinuous transmission (DTX) or cell discontinuous reception (DRX) for at least one of the plurality of TRPs; and based at least in part on the indication, performing an action comprising to change the activation state for at least one of the cell DTX or the cell DRX for the at least one of the plurality of TRPs.

Another aspect provides a method for wireless communications by an apparatus. The method includes maintaining a connection with a plurality of TRPs of at least one serving cell of the apparatus; receiving an indication for each TRP of the plurality of TRPs, wherein at least one indication indicates to change an activation state for at least one of cell DTX or cell DRX for the corresponding TRP; and based at least in on the at least one indication indicating to change the activation state, changing the activation state for at least one of the cell DTX or the cell DRX for the TRP associated with the at least one indication.

Another aspect provides a method for wireless communications by an apparatus. The method includes establishing a connection with a UE; and sending, to the UE, an indication associated with a plurality of TRPs, including the apparatus, indicating to change an activation state for at least one of cell DTX or cell DRX for at least one of the plurality of TRPs.

Another aspect provides a method for wireless communications by an apparatus. The method includes sending, to a UE via a first TRP of the apparatus, a first indication indicating to change a first activation state for at least one of cell DTX or cell DRX for the first TRP; sending, to the UE via a second TRP of the apparatus, a second indication indicating to change a second activation state for at least one of the cell DTX or the cell DRX for the second TRP; based on the first indication, changing the first activation state for at least one of the cell DTX or the cell DRX for the first TRP; and based on the second indication, changing the second activation state for at least one of the cell DTX or the cell DRX for the second TRP.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5A depicts an example single downlink control information, multiple transmission reception point scenario.

FIG. 5B depicts an example medium access control control element used to activate multiple transmission configuration indicator states for a serving cell of a user equipment.

FIG. 6A depicts an example multiple downlink control information, multiple transmission reception point scenario.

FIG. 6B depicts example control resource set groups.

FIG. 7 depicts example cell discontinuous transmission activation.

FIG. 8 depicts example downlink control information-based cell discontinuous transmission and/or cell discontinuous reception activation and/or deactivation supported for a single transmission reception scenario.

FIGS. 9A and 9B depict example downlink control information-based cell discontinuous transmission and/or cell discontinuous reception activation and/or deactivation for multiple transmission reception points.

FIGS. 10A and 10B depict example downlink control information for downlink control information-based cell discontinuous transmission and/or cell discontinuous reception activation and/or deactivation for multiple transmission reception points.

FIG. 11 depicts example reception of an indication for each transmission reception point connected to a user equipment, where each indication indicates to change an activation state for cell discontinuous transmission and/or cell discontinuous reception for the corresponding transmission reception point.

FIG. 12 depicts a method for wireless communications.

FIG. 13 depicts another method for wireless communications.

FIG. 14 depicts another method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for activation and/or deactivation of cell discontinuous transmission (DTX) and/or cell discontinuous reception (DRX) in scenarios where, for example, a user equipment (UE) is connected to a plurality of transmission reception points (TRPs) (e.g., where each TRP is a set of geographically co-located antennas at a network entity). Specifically, in some wireless communications networks, a network entity (e.g., a base station (BS)) may use more than one TRP to communicate with a UE. Communications using a plurality of TRPs beneficially supports increased mobile data traffic and enhances wireless coverage.

Cell DTX and cell DRX are power-saving mechanisms used to reduce the signaling load on a cell, which may refer to a portion, partition, or segment of wireless communication coverage served by a network entity in a wireless communication system. For example, in some cases, cell DTX may be configured for a cell such that an alternating pattern of (1) one or more cell DTX active time periods and (2) one or more cell DTX inactive time periods are defined for the cell. During a cell DTX active time period, a UE may receive downlink channel(s) and/or signal(s) from the cell. During a cell DTX inactive time period, the UE may not receive downlink channel(s) and/or signal(s) from the cell. In some cases, a cell DRX may be configured for a cell such that an alternating pattern of (1) one or more cell DRX active time periods and (2) one or more cell DRX inactive time periods are defined for the cell. During a cell DRX active time period, the UE may transmit uplink channel(s) and/or signal(s) to the cell. During a cell DRX inactive time period, the UE may not transmit the uplink channel(s) and/or signal(s) to the cell.

Cell DTX and cell DRX have conventionally been supported in single TRP scenarios, such as where a UE is only connected to one TRP at a network entity. For example, to activate and/or deactivate cell DTX and/or cell DRX (e.g., activate and/or deactivate the active and inactive time period(s) for cell DTX and/or cell DRX) in single TRP scenarios, RRC signaling and/or a group common (GC) DCI (e.g., intended for multiple UEs) may be used. In cases where a GC DCI is used, the GC DCI may be sent from a single TRP connected to the UE and include cell DTX and/or cell DRX activation/deactivation information for the single TRP (e.g., may include bits only associated with the single TRP, where the bits are used to activate/deactivate cell DTX and/or cell DRX for the single TRP).

Implementing cell DTX and/or cell DRX in multiple TRP scenarios (e.g., where a UE is instead connected to multiple TRPs) represents a technical problem in the art. For example, a first technical challenge includes adaptation of the activation/deactivation signaling to support activation/deactivation of cell DTX and/or cell DRX at multiple TRPs. For example, adaptations for the signaling may be used to address which TRP is permitted to transmit the activation/deactivation indication, how many activation/deactivation indications may be transmitted for multiple TRPs, and/or how the bits included in the signaling carrying the activation/deactivation indication may be designed to communicate information about multiple TRPs connected to the UE. Adaptations for the signaling may also be used to support activation/deactivation flexibility at the TRPs such that cell DTX and/or cell DRX can be activated and/deactivated for different sets of TRPs (e.g., one or more TRPs) connected to the UE at different times.

A second technical challenge involves the activation and/or deactivation of cell DTX and/or cell DRX in non-ideal backhaul scenarios (e.g., scenarios where latency is generally between 2-60 milliseconds (ms) and throughout is generally from 10 megabits per second (Mbps) up to 10 gigabits per second (Gbps)). For example, in non-ideal backhaul scenarios, latency between two TRPs connected to a same UE may be large. As such, if a first TRP provides the UE with an indication to activate/deactivate cell DTX and/or cell DRX for a second TRP and the first TRP coordinates with the second TRP (e.g., via backhaul) to inform the second TRP about the activation/deactivation, cell DTX and/or cell DRX activation and/or deactivation misalignment may occur between the UE and the second TRP. Specifically, latency between the first TRP and the second TRP may be much larger than the application delay between when the indication is received at the UE and applied and when cell DTX and/or cell DRX is activated by the second TRP. This misalignment between the UE and the second TRP may cause various technical problems, such as reduced communication reliability (e.g., due to misalignment between non-active and active DTX time periods and/or non-active and active DRX time periods) and/or increased signaling overhead (e.g., due to the UE missing transmission(s) from the network entity based on misalignment of non-active and active DTX time periods, and thus prompting one or more retransmissions), to name a few.

To overcome the aforementioned technical challenges and improve upon the state of the art, aspects described herein provide techniques that support the implementation of cell DTX and/or cell DRX power-saving mechanisms in scenarios where a UE is connected to multiple TRPs. These techniques beneficially enable the flexible activation of cell DTX and/or cell DRX at one or more TRPs, among multiple TRPs, connected to a UE. Further, the techniques enable the flexible deactivation of cell DTX and/or cell DRX for one or more TRPs, among multiple TRPs, connected to a UE. Such activation and/or deactivation may be accomplished via, for example, the use of RRC and/or DCI signaling. Different bit designs for DCI signaling are provided herein to support the activation/deactivation of cell DTX and/or cell DRX in scenarios where a UE is connected to multiple TRPs. DCI activation/deactivation may be enabled for both single DCI scenarios where a UE is configured to monitor for DCI from one TRP (without monitoring for DCI from the other TRP) and multiple DCI scenarios where a UE is configured to monitor for DCI from multiple TRPs connected to the UE. Further, techniques for cell DTX and/or cell DRX activation/deactivation timing alignment between each TRP and a UE connected to each TRP are provided herein.

Notably, the techniques described herein enable the use of power-saving mechanisms, such as cell DTX and/or cell DRX, across a wider set of user cases/scenarios to increase net energy saving at the network. For example, the techniques described herein enable the use of cell DTX and/or cell DRX in multiple TRP scenarios. Cell DTX and/or cell DRX implemented in multiple TRP scenarios may help to reduce signaling load on a cell(s), while also allowing for increased reliability, coverage, and capacity performance through the connection of a UE to the network via multiple TRPs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

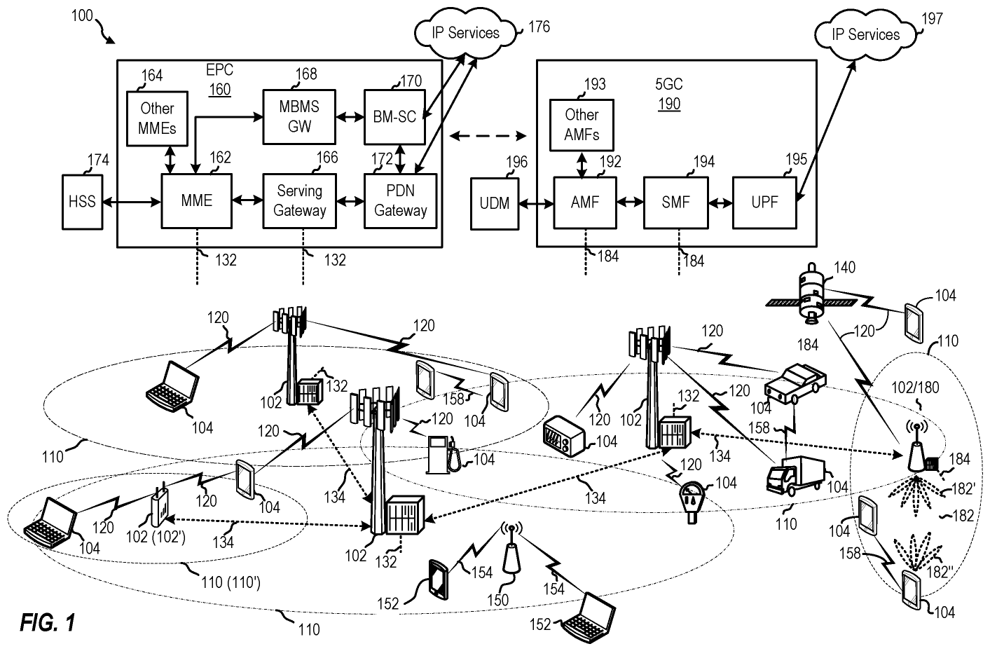

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such, communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

As described above, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

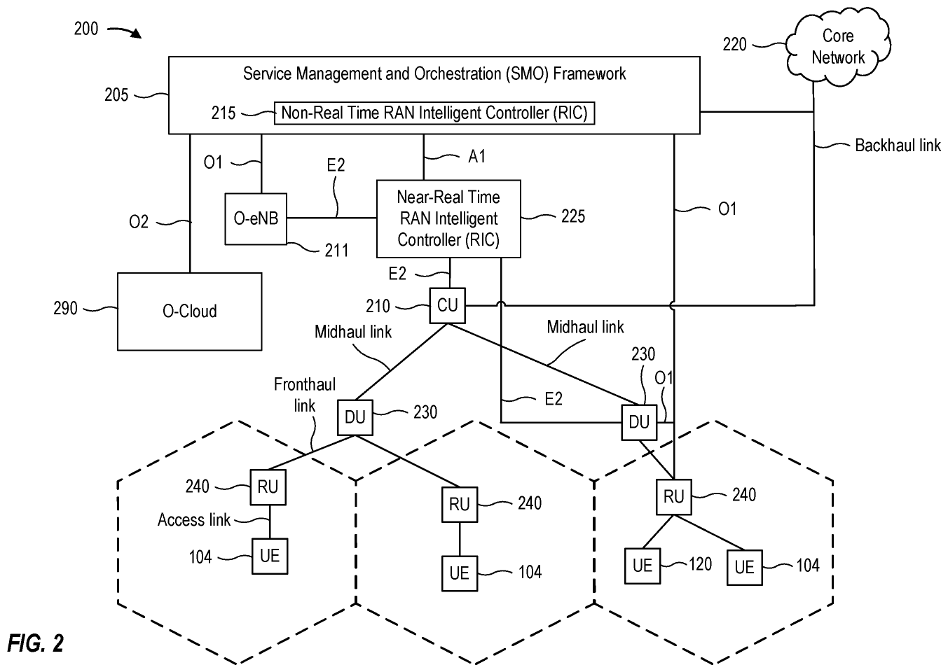

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3^{rd} Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

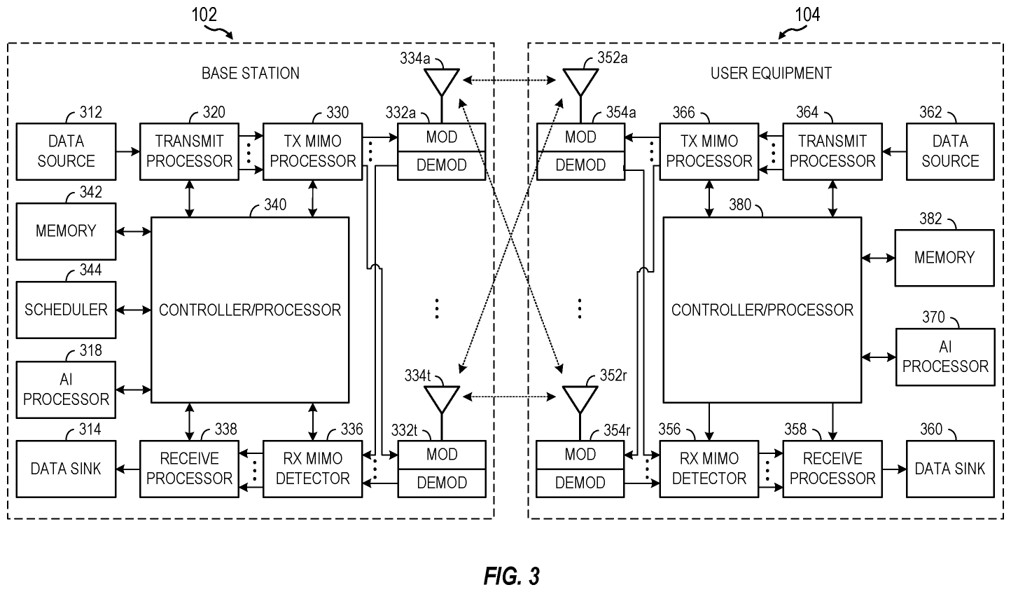

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

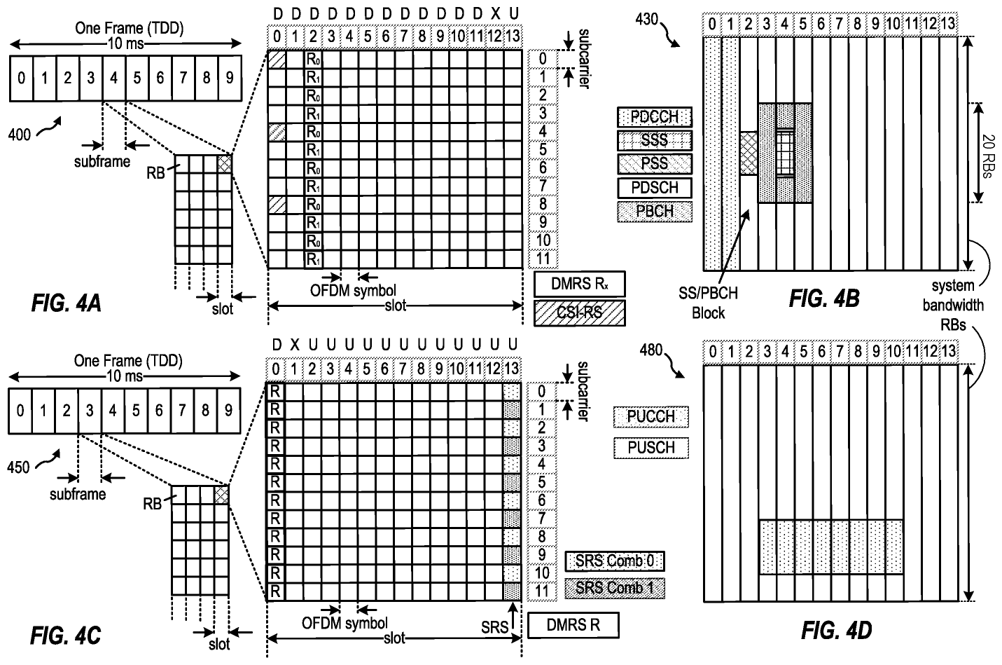

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Control Resource Sets (CORESETs)

A control resource set (CORESET) for an orthogonal frequency division multiple access (OFDMA) system (e.g., a communications system transmitting PDCCHs using OFDMA waveforms) may include one or more control resource (e.g., time and frequency resources) sets, configured for conveying PDCCH, within the system bandwidth (e.g., a specific area on the NR downlink resource grid) and a set of parameters used to carry PDCCH (e.g., DCI). For example, a CORESET may be similar in area to an LTE PDCCH area (e.g., the first 1, 2, 3, 4 OFDM symbols in a subframe).

Within each CORESET, one or more search spaces (e.g., common search space (CSS), UE-specific search space (USS), etc.) may be defined for a given UE. Search spaces are generally areas or portions where a communications device (e.g., a UE, such as UE 104 of FIGS. 1 and 3) may look for (e.g., monitor for) control information.

A CORESET is a set of time and frequency domain resources, defined in units of resource element groups (REGs). Each REG may include a fixed number (e.g., twelve) tones/subcarriers in one symbol period (e.g., a symbol period of a slot), where one tone in one symbol period is referred to as a RE. A fixed number of REGs, such as six, may be included in a control channel element (CCE). Sets of CCEs may be used to transmit PDCCHs, with different numbers of CCEs in the sets used to transmit PDCCHs using differing aggregation levels. Multiple sets of CCEs may be defined as search spaces for UEs, and thus a network entity (e.g., such as BS 102 of FIGS. 1 and 3, or a disaggregated base station as discussed with respect to FIG. 2) may transmit a PDCCH to a UE by transmitting the PDCCH in a set of CCEs that is defined as a decoding candidate within a search space for the UE. The UE may receive the PDCCH by searching in search spaces for the UE and decoding the PDCCH transmitted by the network entity.

When a UE is connected to a cell (e.g., of a network entity), the UE may receive an MIB. The MIB can be in an SS/PBCH block (e.g., in the PBCH of the SS/PBCH block) on a synchronization raster (sync raster). In some scenarios, the sync raster may correspond to an SSB. From the frequency of the sync raster, the UE may determine an operating band of the cell. Based on a cell's operation band, the UE may determine a minimum channel bandwidth and a subcarrier spacing (SCS) of the channel. The UE may then determine an index from the MIB (e.g., four bits in the MIB, conveying an index in a range 0-15).

Given this index, the UE may look up or locate a CORESET configuration (e.g., the initial CORESET configured via the MIB may be referred to as CORESET #0). This may be accomplished from one or more tables of CORESET configurations. These configurations (including single table scenarios) may include various subsets of indices indicating valid CORESET configurations for various combinations of minimum channel bandwidth and SCS. In some arrangements, each combination of minimum channel bandwidth and SCS may be mapped to a subset of indices in the table.

Alternatively or additionally, the UE may select a search space CORESET configuration table from several tables of CORESET configurations. These configurations can be based on a minimum channel bandwidth and SCS. The UE may then look up a CORESET configuration (e.g., a Type0-PDCCH search space CORESET configuration) from the selected table, based on the index. After determining the CORESET configuration (e.g., from the single table or the selected table), the UE may then determine the CORESET to be monitored (as mentioned above) based on the location (in time and frequency) of the SS/PBCH block and the CORESET configuration. The UE may then monitor the CORESET, decode PDCCH in the CORESET, and receive PDSCH that was allocated by the PDCCH.

Different CORESET configurations may have different parameters that define a corresponding CORESET. For example, each configuration may indicate a number of RBs (e.g., 24, 48, or 96), a number of symbols (e.g., 1-3), as well as an offset (e.g., 0-38 RBs) that indicates a location in frequency.

Further, REG bundles may be used to convey CORESETs. REGs in an REG bundle may be contiguous in a frequency and/or a time domain. In certain cases, the time domain may be prioritized before the frequency domain. REG bundle sizes may include: 2, 3, or 6 for interleaved mapping and 6 for non-interleaved mapping.

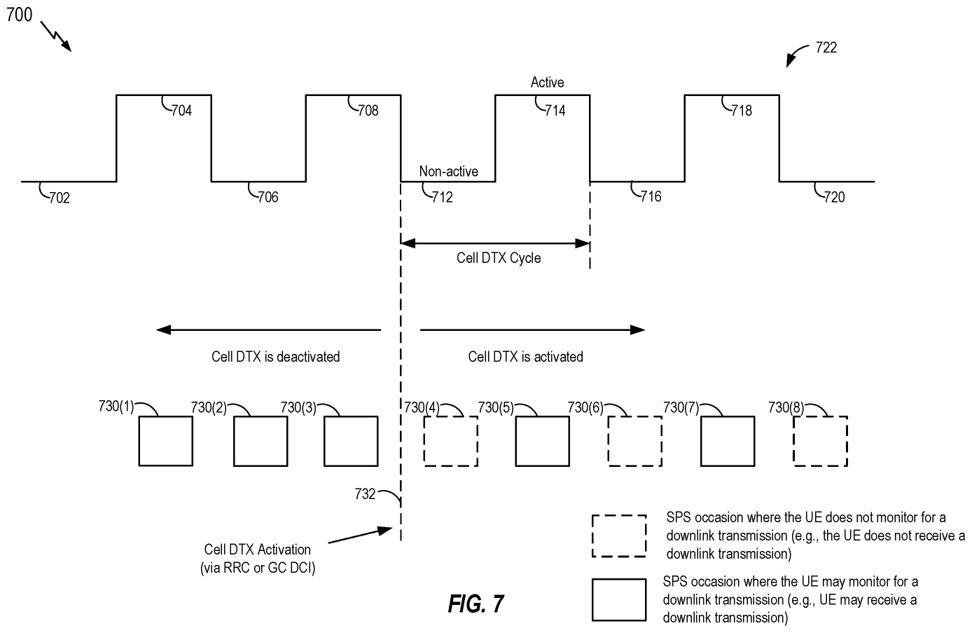

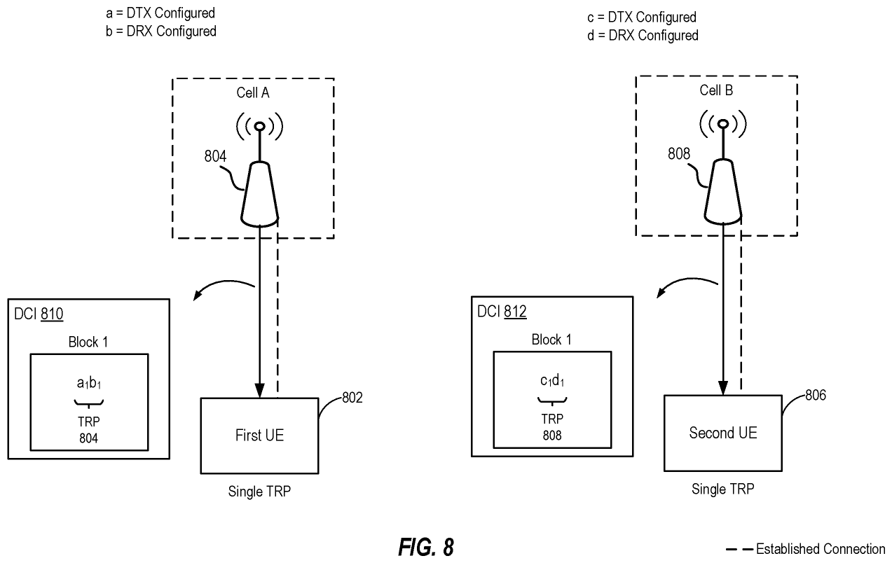

As described in detail below with respect to FIG. 6A, to support multiple PDCCH monitoring at a UE, the UE may receive signaling indicating a plurality of CORESET groups that the UE is configured to monitor for downlink control information (DCI). Each CORESET group may correspond to a different TRP connected to the UE (e.g., scenarios involving the connection of a UE to multiple TRPs are described in detail below).

### Aspects Related to Transmission Configuration Indication (TCI) States

In many cases, a UE may store or obtain information indicating which assumptions it may make on a channel corresponding to different transmissions. For example, the UE may have information indicating which reference signals (RSs) it may use to estimate the channel in order to decode a transmitted signal (e.g., a PDCCH and/or PDSCH). to the UE may also be able to report relevant channel state information (CSI) to a network entity (e.g., such as BS 102 of FIGS. 1 and 3, or a disaggregated base station as discussed with respect to FIG. 2) for scheduling, link adaptation, and/or beam management purposes. In some generations of wireless technologies (e.g., such as NR), the concept of quasi co-location (QCL) and transmission configuration indicator (TCI) states may be used to convey information about these assumptions.

QCL assumptions may be defined in terms of channel properties. Per 3GPP Technical Specification (TS) 38.214, two antenna ports are said to be quasi-co-located if properties of the channel over which a symbol on one antenna port is conveyed can be inferred from the channel over which a symbol on the other antenna port is conveyed. Different RSs may be considered quasi co-located (“QCL'd”) if a receiver (e.g., a UE, such as UE 104 of FIGS. 1 and 3) can apply channel properties determined by detecting a first RS to help detect a second RS. TCI states may include configurations such as QCL-relationships, for example, between the downlink RSs in one CSI-RS set and the PDSCH DMRS ports.

A UE may be configured with up to M TCI-States. Configuration of the M TCI-States can come about via higher layer signaling, while a UE may be signaled to decode PDSCH according to a detected PDCCH with DCI indicating one of the TCI states. Each configured TCI state may include one RS set TCI-RS-SetConfig that indicates different QCL assumptions between certain source and target signals.

QCL information and/or types may, in some scenarios, depend on or be a function of other information. For example, the QCL types indicated to the UE may be based on higher layer parameter QCL-Type and may take one or a combination of the following types:
QCL-TypeA: {Doppler shift, Doppler spread, average delay, delay spread},
QCL-TypeB: {Doppler shift, Doppler spread},
QCL-TypeC: {average delay, Doppler shift}, and
QCL-TypeD: {Spatial RX parameter}.

Spatial QCL assumptions (QCL-TypeD) may be used to help a UE select an analog receive beam (e.g., during beam management procedures). For example, an SSB resource indicator may indicate a same beam for a previous RS should be used for a subsequent transmission.

As described above, a ControlResourceSet information element (CORESET IE), sent via RRC signaling, may convey information regarding a CORESET configured for a UE. The CORESET IE generally includes a CORESET ID, an indication of frequency domain resources (e.g., number of RBs) assigned to the CORESET, contiguous time duration of the CORESET in a number of symbols, and TCI states. A particular TCI state for a given UE (e.g., for unicast PDCCH) may be conveyed to the UE via a Medium Access Control (MAC) Control Element (MAC-CE). The particular TCI state may be selected from the set of TCI states conveyed by the CORESET IE.

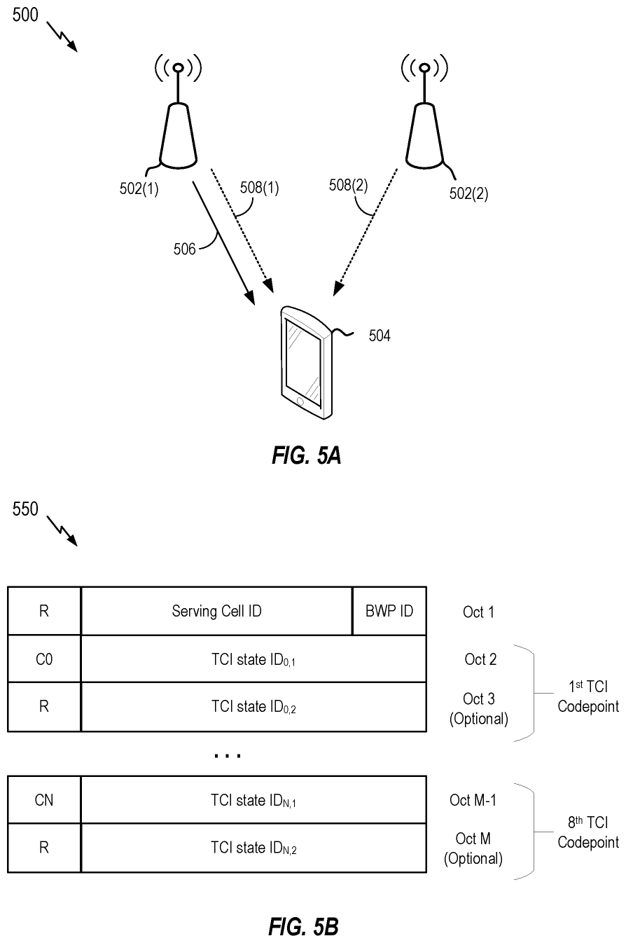

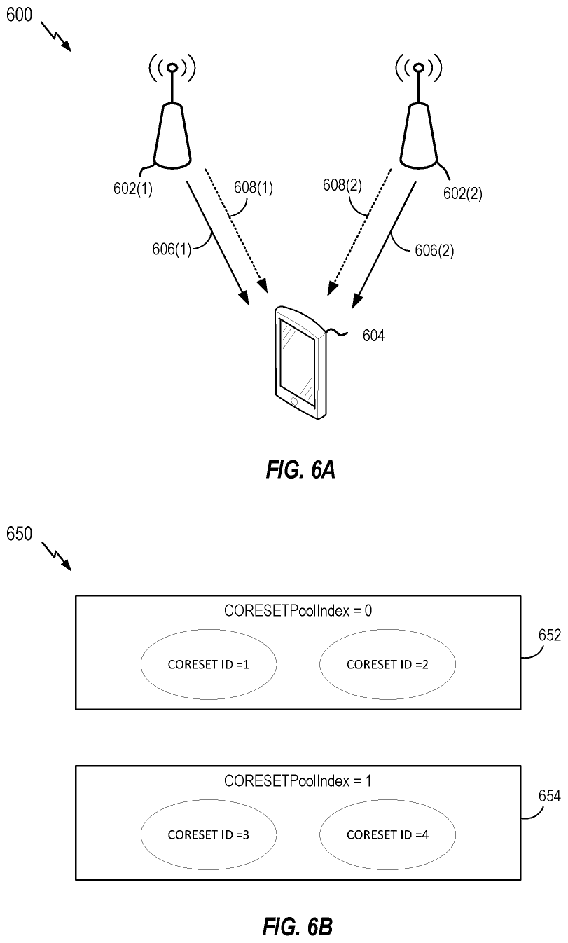

As described in detail below with respect to FIG. 5A, to support single PDCCH monitoring at a UE where the UE is connected to multiple TRPs, the UE may receive signaling activating multiple TCI states (e.g., configured at the UE). Each activated TCI state may correspond to a different TRP connected to the UE (e.g., scenarios involving the connection of a UE to multiple TRPs are described in detail below).

### Aspects Related to TRPs

Wireless communications networks, such as NR, may utilize TRPs to improve reliability, coverage, and capacity performance through flexible deployment scenarios. For example, a network entity (e.g., BS) may use more than one TRP to establish a connection and communicate with a UE, thereby allowing the UE to support increased mobile data traffic and enhance wireless coverage.

In 3GPP (e.g., beginning with Release 16 and supported by later releases), a UE having an established connection to two or more UEs is referred to as a “multi-TRP operation.” Various modes of operation are supported for such multi-TRP operations in 3GPP Release 16. For example, a first mode, “Mode 1” also referred to as “single DCI multi-TRP,” is depicted in FIG. 5A, and a second mode, “Mode 2” also referred to as “multiple DCI multi-TRP,” is depicted in FIG. 6A.

FIG. 5A depicts an example single DCI multi-TRP scenario 500 (e.g., “Mode 1” scenario), where a single PDCCH 506 (e.g., carrying DCI) schedules PDSCHs from multiple TRPs (e.g., a PDSCH per TRP). For example, as shown in FIG. 5A, two TRPs, a first TRP 502(1) and a second TRP 502(2), serve a single UE 504. First TRP 502(1) transmits PDCCH 506 to UE 504. PDCCH 506 may carry DCI scheduling a first PDSCH 508(1) (e.g., a first downlink data transmission) from first TRP 502(1) to UE 504 and a second PDSCH 508(2) (e.g., a second downlink data transmission) from second TRP 502(2) to UE 504.

In this mode, TRP 502(1) and TRP 502(2) transmit different spatial layers in overlapping RBs/symbols (spatial division multiplexing (SDM). TRP 502(1) and TRP 502(2) may transmit in different RBs (frequency division multiplexing (FDM)) and may transmit in different OFDM symbols (time division multiplexing (TDM). This mode assumes a backhaul with little or virtually no delay (e.g., ideal backhaul).

To support single DCI multi-TRP scenarios, multiple TCI states (e.g., configured at UE 504) may be activated via a MAC-CE, where each activated TCI state corresponds to a different TRP. FIG. 5B depicts an example MAC-CE 550 used to activate multiple TCI states for a serving cell of a UE. MAC-CE 550 in FIG. 5B may be a UE-specific PDSCH MAC-CE.

As shown, MAC-CE 550 includes a “serving cell ID” field and a “BWP ID” field in octet 1 (Oct 1). The serving cell ID field indicates the identity of a serving cell for which MAC-CE 550 applies, and the BWP ID field indicates a downlink BWP for which MAC-CE 550 applies.

Further, MAC-CE 550 includes a first TCI state ID (e.g., TCI state ID_{i,1}) for each codepoint up to N codepoints (e.g., where i and N are integers greater than zero). In addition, for each codepoint i, a field Cᵢ may indicate whether a corresponding octet containing a second TCI state ID (e.g., TCI state ID_{i,2}) is present. For example, a field Cᵢ set to “1,” may indicate that a corresponding octet contains TCI state ID_{i,2}, and a field Cᵢ set to “0,” may indicate that a corresponding octet containing TCI state ID_{i,2} is not present.

TCI state ID_{i,j} indicates the TCI state identified by a TCI-StateId, where i is the index of the codepoint and j denotes the j^{th} TCI state indicated for the i^{th} codepoint in MAC-CE 550 (j=1 or j=2).

FIG. 6A depicts an example multiple DCI multi-TRP scenario 600 (e.g., “Mode 2” scenario), where multiple PDCCHs (e.g., each carrying DCI) schedule respective PDSCH from multiple TRPs. For example, as shown in FIG. 6A, similar to FIG. 5A, two TRPs, a first TRP 602(1) and a second TRP 602(2), serve a single UE 604. First TRP 602(1) transmits a first PDCCH 606(1) to UE 604, and second TRP 602(2) transmits a second PDCCH 606(2) to UE 604. First PDCCH 606(1), from first TRP 602(1), may carry a first DCI that schedules a first PDSCH 608(1) (e.g., transmitted from first TRP 602(1)). Similarly, second PDCCH 606(2), from second TRP 602(2), may carry a second DCI that schedules a second PDSCH 608(2) (e.g., transmitted from second TRP 602(2)). This mode (e.g., Mode 2) can be utilized in both non-ideal and ideal backhaul scenarios. Further, in some cases, a carrier aggregation (CA) framework may be leveraged to treat different TRPs, such as first TRP 602(1) and second TRP 602(2) as different virtual component carriers (CCs), based on the capability UE 604.

TRP 602 differentiation at UE 604, in some cases, may be based on a value of a CORESET pool index (e.g., CORESETPoolIndex), where each CORESET (e.g., up to a maximum of five CORESETs) can be configured with a value of a CORESET pool index. To support multiple PDCCH monitoring at UE 604, as shown in FIG. 6A, up to a maximum of five CORESETs can be configured with up to three CORESETs per TRP 602.

FIG. 6B depicts example control resource set groups 650. As shown, in some examples, a UE may be configured by a higher layer parameter, PDCCH-Config (e.g., a condition in 3GPP specification used to determine whether a UE is configured with multi-DCI based multi-TRP), which contains two different values of CORESETPoolIndex in CORESETs for an active BWP of a serving cell. In some examples, shown at 652, the value of CORESETPoolIndex may be zero (e.g., shown at 652) or one (e.g., shown at 654), which groups the CORESETs into two groups. Each value of CORESETPoolIndex (e.g., each CORESET group) may correspond to a different TRPs, such as the first value corresponding to TRP 602(1) and the second value corresponding to TRP 602(2) in FIG. 6A.

Beyond the CORESET pool index distinction, a UE may be oblivious to differences beyond identifying that different TRPs are used within a same wireless communications system. The UE may monitor for transmissions in different CORESET groups and may infer that transmissions sent in the different CORESET groups come from different TRPs.

### Aspects Related to Cell DTX and Cell DRX

Cell DTX and cell DRX are mechanisms that beneficially reduce the signaling/data (and thus, processing) load on a cell. More specifically, cell DTX and cell DRX are power-saving mechanisms used to limit when channel(s) in a cell are activated/deactivated and/or when signal(s) may be transmitted in the cell.

For example, in some cases, cell DTX may be configured for a cell such that an alternating pattern of (1) one or more cell DTX active time periods and (2) one or more cell DTX inactive time periods are defined for the cell. During a cell DTX active time period configured for a cell, a UE may receive downlink channel(s) and/or signal(s) from the cell. During a cell DTX inactive time period configured for a cell, the UE may not receive downlink channel(s) and/or signal(s) from the cell. As such, during DTX inactive time periods, the network entity may not transmit and the UE may not receive any downlink signal(s).

Similarly, in some cases, cell DRX may be configured for a cell such that an alternating pattern of (1) one or more cell DRX active time periods and (2) one or more cell DRX inactive time periods are defined for the cell. During a cell DRX active time period configured for a cell, a UE may transmit uplink channel(s) and/or signal(s) to the cell. During a cell DRX inactive time period configured for a cell, a UE may not transmit uplink channel(s) and/or signal(s) to the cell. As such, during DRX inactive time periods, the UE may not transmit and the network entity may not receive any uplink signal(s).

In some cases, only cell DTX is configured for a cell. In some cases, only cell DRX is configured for a cell. In some cases, both cell DTX and cell DRX are configured for a cell.

Cell DTX configured for a cell may be activated and deactivated via RRC signaling and/or a group common (GC) DCI (e.g., including a cell DTX activation/deactivation indication for multiple UEs). Specifically, in certain aspects, GC DCI format 2_9 may be used to provide an indication to multiple UEs, where the indication indicates to activate or deactivate cell DTX for a cell. Similarly, cell DRX configured for a cell may be activated and deactivated via RRC signaling and/or a GC DCI. Specifically, in certain aspects, GC DCI format 2_9 may be used to provide an indication to multiple UEs, where the indication indicates to activate or deactivate cell DRX for a cell. In some cases, RRC signaling and/or GC DCI are used to (1) activate or deactivate cell DTX and (2) activate or deactivate cell DRX for a cell simultaneously (e.g., the RRC signaling and/or the GC DCI may carry both activation status change indications).

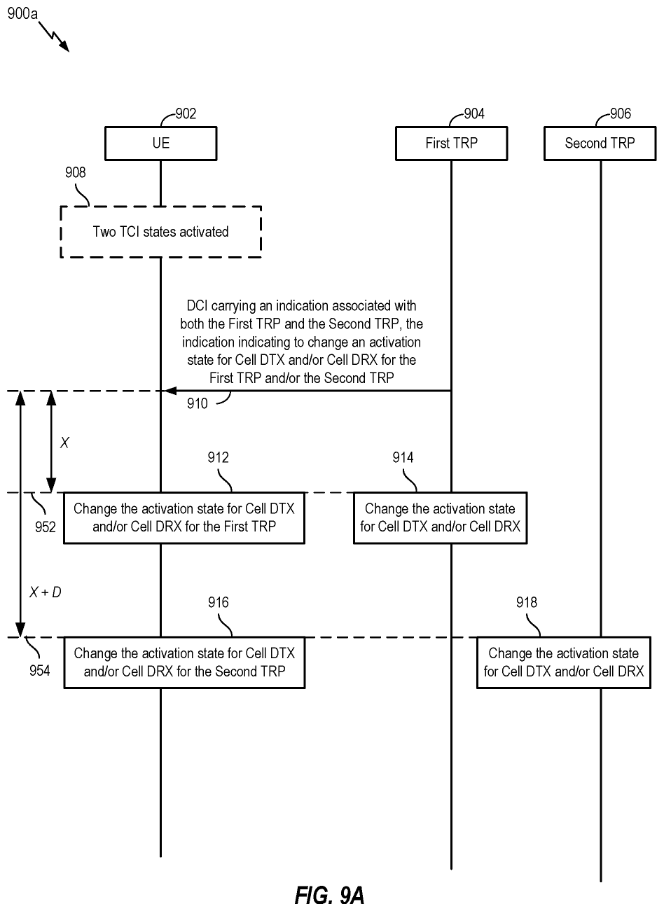

FIG. 7 depicts example cell DTX activation 700 via RRC signaling or GC DCI. In FIG. 7, a network entity (not shown) may use semi-persistent scheduling (SPS) to allocate time and frequency resources to a UE (not shown) for downlink transmission from the network entity to the UE. With SPS, the network entity may allocate the same radio resources to the UE for a predetermined number of subframes. This means that the radio resources are reserved for the UE, and other UEs may not be allowed to use them during the allocated time. The advantage of SPS is that it reduces the signaling overhead and delay associated with traditional dynamic scheduling approaches where the network entity has to repeatedly inform the UE about the allocated radio resources.

Time and frequency resources allocated to a UE for downlink transmissions may be referred to herein as SPS occasions 730 (e.g., SPS occasions 730(1)-(8) in FIG. 7). The UE may be configured to monitor these SPS occasions 730 for semi-persistently scheduled transmissions in the downlink.

As shown in FIG. 7, a cell associated with the network entity is configured for cell DTX. A cell DTX pattern 722 defined for the cell includes (1) cell DTX active time periods 704, 708, 714, 718 and (2) cell DTX inactive time periods 702, 706, 712, 716, and 720. When cell DTX is activated, a UE communicating with a network entity in the cell (1) may monitor SPS occasions for downlink transmission during cell DTX active time periods 704, 708, 714, 718 and (2) may not monitor SPS occasions for downlink transmission (e.g., no downlink transmission sent by the network entity to the UE) during cell DTX inactive time periods 702, 706, 712, 716, and 720.

For example, prior to time 732 in FIG. 7, cell DTX is deactivated. As such, the UE may monitor SPS occasions 730(1), 730(2), and 730(3) for downlink transmissions from the network entity. Based on the monitoring, the UE may receive downlink transmissions from the network entity.

At time 732, however, the UE may receive an indication to activate cell DTX (e.g., change an activation state for cell DTX from “deactivation” to “activation”). In certain aspects, the indication to activate cell DTX is received by the UE via RRC signaling. In certain aspects, the indication to activate cell DTX is received by the UE via a DCI, such as a GC DCI. The CG DCI may carry an activation/deactivation command for one or multiple serving cells. The UE may monitor for the GC DCI in only one serving cell.

The activation indication received by the UE at time 732 may activate cell DTX, and more specifically, after an activation time for the activation indication, cell DTX pattern 722 may be activated. As used herein, the activation time may be a starting application time (e.g., such as a definite symbol, subframe, frame, slot, etc.) where cell DTX is activated or deactivated and/or where cell DRX is activated or deactivated after receiving an activation/deactivation indication (e.g., via RRC, DCI, etc.). In particular, after receiving signaling including the activation/deactivation indication, a UE may take time to process the activation/deactivation indication, such as time to decode the activation/deactivation indication and apply the activation/deactivation indication to change the activation status for cell DTX and/or cell DRX. In some cases, the activation time is defined in the 3GPP specification. In some cases, the activation time is equal to 3 millisecond (ms) after receiving the activation/deactivation indication at the UE.

Activating cell DTX (e.g., activating cell DTX pattern 722) after an activation time for the activation indication (e.g., received at time 732) may activate downlink channel(s) associated with the cell during the cell DTX active time periods 714 and 718 (and others not shown in FIG. 7), thereby enabling the transmission of downlink transmission(s) to the UE during these time periods. As such, during cell DTX active time periods 714 and 718, the UE may monitor for semi-persistently scheduled downlink transmissions. Based on the monitoring, the UE may receive one or more downlink transmissions.

Further, activating cell DTX (e.g., activating cell DTX pattern 722) after an activation time for the activation indication (e.g., received at time 732) may deactivate downlink channel(s) associated with the cell during the cell DTX inactive time periods 712, 716, and 720 (and others not shown in FIG. 7) such that downlink transmission(s) to the UE during these time periods are not permitted. Accordingly, during cell DTX inactive time periods 712, 716, and 720, the UE may not monitor for semi-persistently scheduled downlink transmissions and further may not receive any downlink transmissions. For example, the UE may skip monitoring the PDCCH for DCI with DCI format 2_X (X=0, 1, . . . , 5) during cell DTX inactive time periods 712, 716, and 720. Further, the UE may skip monitoring a USS defined for the UE to monitor for PDCCH.

Similar techniques described in FIG. 7 for activating cell DTX and monitoring for downlink transmissions during cell DTX activation may be applied when activating cell DRX. However, when cell DRX is activated, the UE may, in active time periods, communicate uplink data to a network entity, and in inactive time period, not communicate any uplink data to the network entity (e.g., instead of downlink transmission(s) when cell DTX is activated). For example, during cell DRX inactive time periods, the UE may not transmit any scheduling requests (SRs), where an SR is a physical layer message sent by the UE to the network entity to request an uplink grant to send uplink data over a PUSCH. As another example, during cell DRX inactive time periods, the UE may not transmit any CSI reports (e.g., periodic/semi-persistent (P/SP) CSI).

Although cell DTX and cell DRX are beneficial power-saving mechanisms that may be advantageously used to reduce signaling (e.g., data) load in a cell, cell DTX and cell DRX are not currently supported for implementations where a UE has established a connection with a plurality of TRPs (e.g., implementations depicted and described with respect to FIGS. 5A and 6A). Further, understanding how to support cell DTX and cell DRX, and specifically activation/deactivation of cell DTX and/or cell DRX for one or more TRPs connected to a UE that is connected to a plurality of TRPs, may be challenging.

As described above, a first technical challenge associated with implementing cell DTX and/or cell DRX in multiple TRP scenarios involves the activation and/or deactivation of cell DTX and/or cell DRX across TRPs, especially in non-ideal backhaul scenarios. For example, a UE may be connected to a first TRP and a second TRP, similar to the scenarios depicted and described with respect to FIGS. 5A and 6A. The first TRP may send an indication to the UE indicating that cell DTX and/or cell DRX is to be activated for both the first TRP and the second TRP connected to the UE. The UE may activate cell DTX and/or cell DRX for both the first TRP and the second TRP, based on the received indication, after an activation time for (e.g., such as 3 ms after) the indication (e.g., as described above with respect to FIG. 7). Activation of cell DTX and/or cell DRX by the UE for the first TRP may align with an activation time of cell DTX and/or cell DRX by the first TRP that sent the indication to the UE; however, activation of cell DTX and/or cell DRX by the UE may be misaligned with cell DTX and/or cell DRX activation and/or deactivation by the second TRP.

Specifically, the first TRP may also coordinate with the second TRP (via backhaul) to inform the second TRP about the activation (e.g., the change in activation status) for cell DTX and/or cell DRX. However, due to high latency between the first TRP and the second TRP when the first TRP and the second TRP belong to different cells, the second TRP may not have enough time to receive the message from the first TRP, process the message, and activate cell DTX and/or cell DRX at the second TRP by the activation time, e.g., when the UE activates cell DTX and/or cell DRX (e.g., latency between the first TRP and the second TRP may be much larger than the application delay between when the indication is received at the UE and when cell DTX and/or cell DRX is activated for the second TRP, by the UE). This misalignment between the UE and the second TRP may cause various technical problems, such as reduced communication reliability and/or increased signaling overhead, to name a few.

Further as described above, a second technical challenge associated with implementing cell DTX and/or cell DRX in multiple TRP scenarios involves adaptation of the signaling to support activation of cell DTX and/or cell DRX at multiple TRPs. For example, as described in FIG. 7, RRC signaling and/or a GC DCI may be used to (1) activate cell DTX, (2) deactivate cell DTX, (3) activate cell DRX, and/or (4) deactivate cell DRX. This signaling may include bits associated with a single TRP that a UE receiving the signaling is connected to, where the bits indicate whether cell DTX and/or cell DRX should be activated for the TRP.

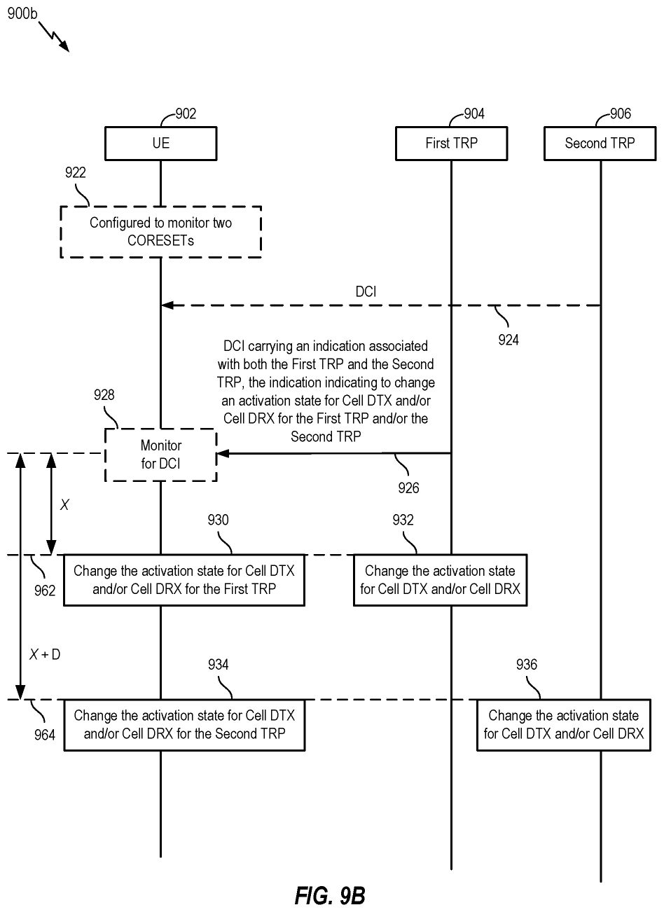

For example, as shown in FIG. 8, in a single TRP implementation, a first UE 802 is connected to a first TRP 804 (e.g., belonging to cell A), and a second UE 806 is connected to a second TRP 808 (e.g., belonging to cell B). To activate and/or deactivate cell DTX and cell DRX at first UE 802, first TRP 804 may send DCI 810 to first UE 802. DCI 810 includes a first bit “a₁” and a second bit “b₁.” First bit, a₁, may indicate whether cell DTX is activated/deactivated at first TRP 804, while second bit, b₁, may indicate whether cell DRX is activated/deactivated at first TRP 804. For example, a₁b₁ bits set to “01” in DCI 810 may indicate that cell DTX is not be activated for first TRP 804, but that cell DRX should be activated for first TRP 804.

Similarly, to activate and/or deactivate cell DTX and cell DRX at second UE 806, second TRP 808 may send DCI 812 to second UE 806. DCI 812 includes a first bit “c₁” and a second bit “d₁.” First bit, c₁, may indicate whether cell DTX is activated/deactivated at second TRP 808, while second bit, d₁, may indicate whether cell DRX is activated/deactivated at second TRP 808.

To support multiple TRP scenarios, additional signaling designs may need to be considered. These additional signaling designs may take into consideration which TRP is transmitting the indication, how many indications are being transmitted for multiple TRPs, and/or how the bits may be designed to communicate information about multiple TRPs connected to a UE, to name a few.

Further, supporting activation/deactivation flexibility at the TRPs may need to be addressed. For example, signaling in multiple TRP scenarios may need to allow for the activation/deactivation of cell DTX and/or cell DRX at a first TRP connected to a UE while cell DTX and/or cell DRX remains deactivated/activated at a second TRP.

### Example Aspects Related to Cell DTX and/or Cell DRX Activation/Deactivation for Multiple TRPs

Aspects described herein overcome the aforementioned technical challenges and improve upon the state of the art by providing techniques that may be used to support the implementation of cell DTX and/or cell DRX power-saving mechanisms in scenarios where a UE is connected to multiple TRPs. For example, the techniques described herein enable changing an activation state for cell DTX and/or cell DRX for one or more TRPs having an established connection with a same UE. RRC signaling and/or DCI may be used to implement this change at the TRP(s). Notably, the ability to activate cell DTX and/or cell DRX at one TRP, at multiple TRPs, and/or at all TRPs, connected to the UE, using the signaling described herein allows for cell DTX and cell DRX activation/deactivation flexibly across TRPs.

Further, techniques for activating and/or deactivating cell DTX and/or cell DRX at multiple TRPs provided herein beneficially enables alignment of such activation and/or deactivation at each TRP with an activation and/or deactivation of cell DTX and/or cell DRX at the UE. For example, in certain aspects, an indication to change an activation state for cell DTX and/or cell DRX for at least two TRPs may be received by a UE from only one of the two TRPs. To account for latency between the TRPs due to non-ideal backhaul, an activation time for activating and/or deactivating cell DTX and/or cell DRX for each TRP may be different. For example, an activation time for activating and/or deactivating cell DTX and/or cell DRX for a TRP that did not send the indication to the UE may be based on an additional delay offset. The additional delay offset may be configured based on the latency between the TRP that sent the indication and the TRP for which the indication is to be applied.

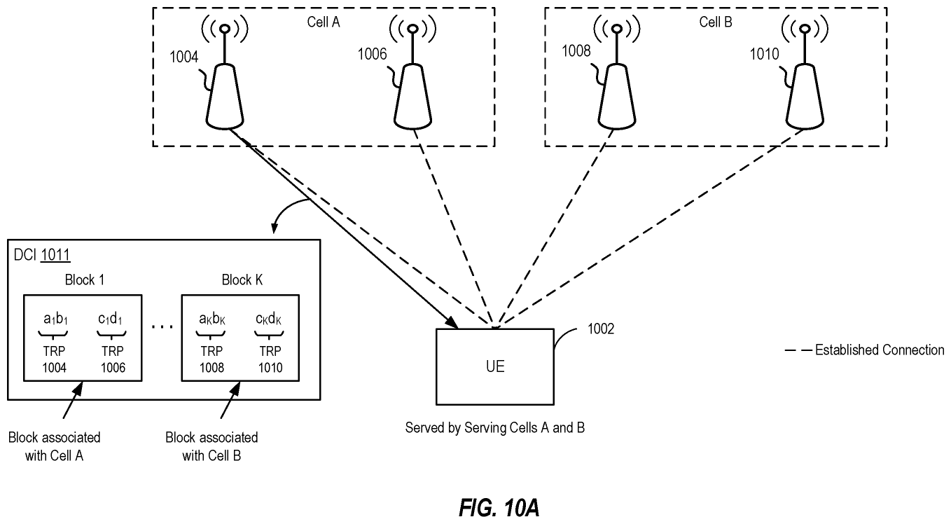

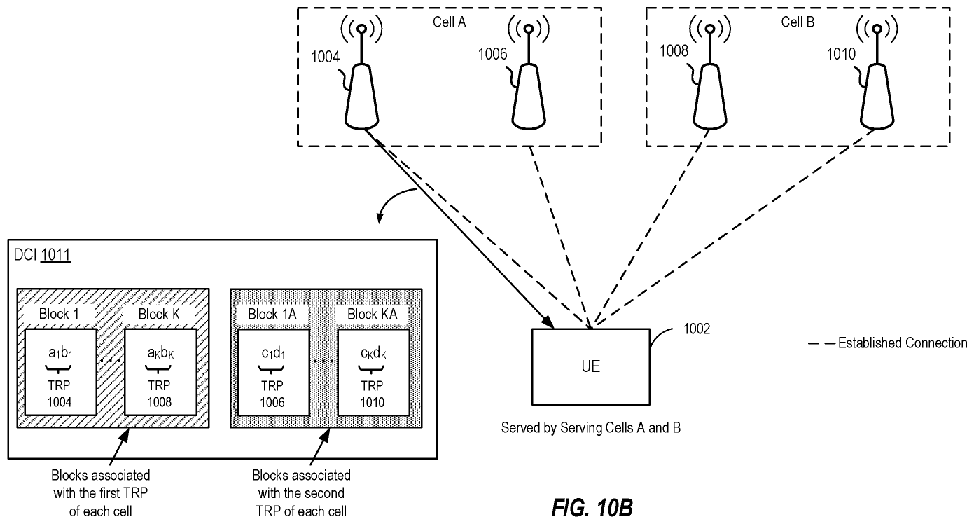

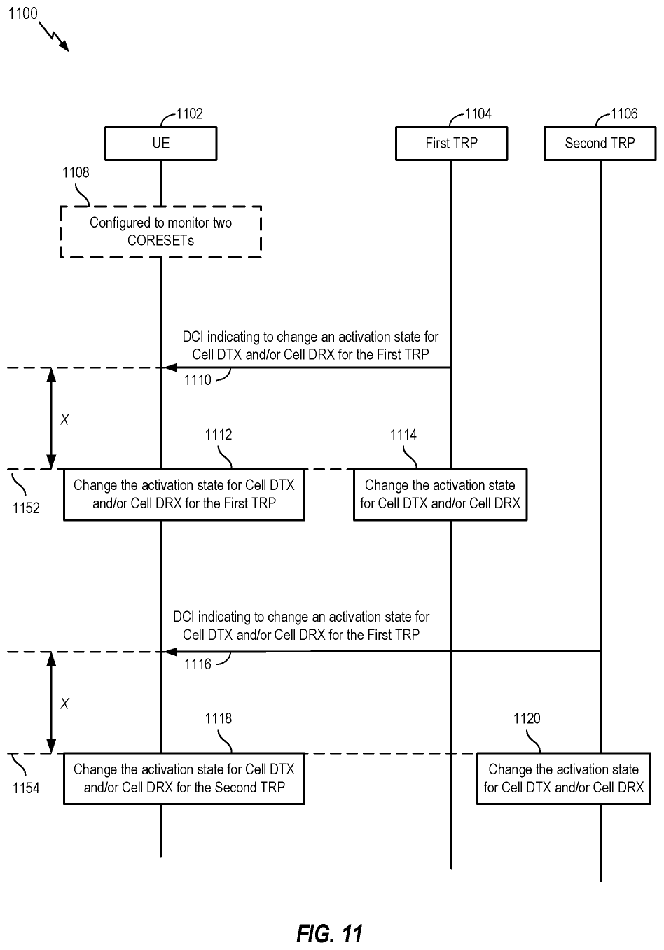

FIGS. 9A-11 depict example techniques used to support cell DTX and/or cell DRX in multiple TRP scenarios. Specifically, FIGS. 9A-9B depict example DCI-based cell DTX and/or cell DRX reception activation and/or deactivation where a UE is connected to multiple TRPs. FIGS. 10A-10B depict example DCI designs for such DCI-based cell DTX and/or cell DRX reception activation and/or deactivation. Further, FIG. 11 depicts example reception of an indication for each TRP connected to a UE, where each indication indicates to change an activation state for cell DTX and/or cell DRX for the corresponding TRP.

### Example Operations of Entities in a Communications Network for Cell DTX and/or Cell DRX Activation and/or Deactivation

FIGS. 9A-9B depict process flows 900a, 900b for communications in a network between a UE 902, a first TRP 904, and a second TRP 906. In some aspects, the first TRP 904 and/or the second TRP 906 may each be a set of (e.g., one or more) geographically co-located antennas at a network entity, such as the BS 102 depicted and described with respect to FIGS. 1 and 3 or a disaggregated base station depicted and described with respect to FIG. 2. The UE 902 may be an example of UE 104 depicted and described with respect to FIGS. 1 and 3. However, in other aspects, UE 902 may be another type of wireless communications device and first TRP 904 and/or second TRP 906 may be a set of geographically co-located antennas at another type of network entity or network node, such as those described herein. In some aspects, the first TRP 904 and the second TRP 906 belong to a same cell or different cells.

Process flow 900a of FIG. 9A depicts example techniques used to support cell DTX and/or cell DRX in single DCI multiple TRP scenarios (e.g., such as the example scenario depicted and described with respect to FIG. 5A). Thus, in process flow 900a, UE 902 maintains a connection with first TRP 904 and second TRP 906 and may to receive signaling indicating two activated TCI states for a serving cell of UE 902. A first activated TCI state may correspond to first TRP 904 and a second activated TCI state may correspond to second TRP 906.

Process flow 900b of FIG. 9B depicts example techniques used to support cell DTX and/or cell DRX in multiple DCI multiple TRP scenarios (e.g., such as the example scenario depicted and described with respect to FIG. 6A). Thus, in process flow 900b, UE 902 maintains a connection with first TRP 904 and second TRP 906, and may receive signaling indicating two CORESET groups that UE 902 is configured to monitor for DCI. A first CORESET group may correspond to first TRP 904 and a second CORESET group may correspond to second TRP 906.

Although process flows 900a, 900b are described with respect to a UE being simultaneously connected to two TRPs, e.g., first TRP 904 and second TRP 906, the operations in process flows 900a, 900b may be similarly applied in cases where a UE has established a connection with more than two TRPs.

In process flow 900a in FIG. 9A, UE 902 maintains a connection with first TRP 904 and second TRP 906, and receives, at 908, signaling indicating two activated TCI states for a serving cell of UE 902. A first activated TCI state may correspond to first TRP 904 and a second activated TCI state may correspond to second TRP 906. Because UE 902 does not receive signaling indicating that UE 902 is monitor two different CORESET groups, UE 902 may monitor for DCI from only one of the TRPs (e.g., single DCI), instead of from both (e.g., multi-DCI).

At 910, based on monitoring for DCI, UE 902 may receive DCI from first TRP 904 only (e.g., UE 902 may not receive DCI from second TRP 906). The received DCI may carry an indication associated with both first TRP 904 and second TRP 906. The indication may indicate to change an activation state for cell DRX and/or cell DRX for the first TRP 904 and/or the second TRP 906. An indication to change an activation state for cell DTX may include an indication to (1) activate cell DTX when cell DTX is currently deactivated or (2) deactivate cell DTX when cell DTX is currently activated. Similarly, an indication to change an activation state for cell DRX may include an indication to (1) activate cell DRX when cell DRX is currently deactivated or (2) deactivate cell DRX when cell DRX is currently activated. The indication may indicate to change an activation status for only first TRP 904, only second TRP 906, and/or both first TRP 904 and second TRP 906.

In the example depicted in FIG. 9A, the indication received by UE 902, at 910 (e.g., via DCI), may indicate to change an activation status for only cell DTX (and not DRX) at both first TRP 904 and second TRP 906. For example, in this example, prior to receiving the indication, cell DTX may have been deactivated for both first TRP 904 and second TRP 906. The indication, received at 910, may indicate to activate cell DTX for both first TRP 904 and second TRP 906.

Based on receiving the indication at 910, UE 902 may activate cell DTX for both first TRP 904 and second TRP 906. Specifically, UE 902 may activate cell DTX for first TRP 904 after a first activation time 952 and activate cell DTX for second TRP 906 after a second activation time 954. The second activation time 954 may be later in time than the first activation time 952. Further, the second activation time 954 may be based on an offset (D) from the first activation time 952.

For example, as shown in FIG. 9A, the first activation time 952 for activating cell DTX for first TRP 904 may occur a period of time, X such as 3 ms, after UE 902 receives the DCI at 910. In certain aspects, the period of time X may be defined in a standard, such as the 3GPP specification. In certain aspects, UE 902 is configured with the period of time X. Both UE 902 and first TRP 904 may activate cell DTX at first activation time 952 such that the activation of cell DTX is aligned at both UE 902 and first TRP 904.

Instead of activating cell DTX for second TRP 906 at the first activation time 952, activation of cell DTX for the second TRP occurs at second activation time 954. The second activation time 954 for activating cell DTX for second TRP 906 may occur a period of time, X such as 3 ms, plus an offset (D) (X+D) after UE 902 receives the DCI at 910. Thus, second activation time 954 may be later in time than the first activation time 952 by offset (D). In certain aspects (not shown in FIG. 9A), UE 902 receives an indication of the offset (D) via RRC signaling.

In certain aspects (not shown in FIG. 9A), UE 902 receives an indication of the offset (D) via a MAC-CE. In certain aspects (not shown in FIG. 9A), UE 902 receives an indication of the offset (D) via DCI. The offset (D) may help to account for latency between the TRPs due to, for example, non-ideal backhaul. For example, because first TRP 904 sent the indication (e.g., via DCI) including information about both first TRP 904 and second TRP 906, UE 902 may also inform second TRP 906 about the information included in the indication. In particular, here, first TRP 904 may inform second TRP 906 that cell DTX is to be activated for second TRP 906. Due to non-ideal backhaul, there may be some delay in first TRP 904 informing second TRP 906 about the change in activation status for cell DTX, second TRP 906 processing this information, and second TRP 906 activating the cell DTX for second TRP 906. Accordingly, UE 902 may wait the additional offset (D) prior to activating the cell DTX for second TRP 906, such that activation of cell DTX at UE 902 and second TRP 906 is aligned in time.

Accordingly, in FIG. 9A, UE 902 changes, at 912, the activation state for cell DTX and/or cell DRX for first TRP 904 at first activation time 952. Further, first TRP 904 changes, at 914, the activation state for cell DTX and/or cell DRX for first TRP 904 at first activation time 952. In this example, UE 902 and first TRP 904 change only an activation state for cell DTX, per the indication received at 910.

Additionally, in FIG. 9A, UE 902 changes, at 916, the activation state for cell DTX and/or cell DRX for second TRP 906 at second activation time 954. Further, second TRP 906 changes, at 918, the activation state for cell DTX and/or cell DRX for second TRP 906 at second activation time 954. In this example, UE 902 and second TRP 906 change only an activation state for cell DTX, per the indication received at 910.

As described above, while process flow 900a depicts example techniques used to support cell DTX and/or cell DRX in single DCI multiple TRP scenarios, process flow 900b depicts example techniques used to support cell DTX and/or cell DRX in multiple DCI multiple TRP scenarios.

In process flow 900b in FIG. 9B, UE 902 maintains a connection with first TRP 904 and second TRP 906, and receives, at 922, signaling indicating two CORESET groups that UE 902 is configured to monitor for DCI. A first CORESET group may correspond to first TRP 904 and a second CORESET group may correspond to second TRP 906. Because UE 902 receives signaling indicating that UE 902 is to monitor two different CORESET groups, UE 902 may be configured to monitor transmissions from both first TRP 904 and second TRP 906.

However, when monitoring for a DCI including information about cell DTX and/or cell DRX for first TRP 904 and second TRP 906, UE 902 may only monitor one of the two CORESETs. For example, UE 902 may monitor a first CORESET group corresponding to first TRP 904 and not monitor a second CORESET group corresponding to second TRP 906 for the DCI-based cell DTX and/or cell DRX indication. In certain aspects, first TRP 904 may be a fixed TRP such that UE 902 monitors for the DCI from the fixed TRP. In certain aspects, UE 902 monitors a search space associated with the first CORESET group to detect DCI, where the search space is also associated with PDCCH (e.g., a configured PDCCH search space to detect DCI 2_9 carrying a cell DTX and/or cell DRX indication).

Because UE 902 does not monitor the second CORESET corresponding to second TRP 906, UE 902 may not receive a DCI from second TRP 906, such as the DCI sent by second TRP at 924 in FIG. 9B.

However, based on monitoring, at 928, for DCI in the first CORESET group corresponding to first TRP 904, at 926, UE 902 may receive DCI from first TRP 904. The received DCI may carry an indication associated with both first TRP 904 and second TRP 906. The indication may indicate to change an activation state for cell DRX and/or cell DRX for the first TRP 904 and/or the second TRP 906. The indication may indicate to change an activation status for only first TRP 904, only second TRP 906, and/or both first TRP 904 and second TRP 906.

In this example depicted in FIG. 9B, the indication received by UE 902, at 926 (e.g., via DCI), may indicate to change an activation status for only cell DTX at both first TRP 904 and second TRP 906. For example, in this example, prior to receiving the indication, cell DTX may have been deactivated for both first TRP 904 and second TRP 906. The indication, received at 910, may indicate to activate cell DTX for both first TRP 904 and second TRP 906.

Based on receiving the indication at 926, UE 902 may activate cell DTX for both first TRP 904 and second TRP 906. Specifically, UE 902 may activate cell DTX for first TRP 904 after a first activation time 962 and activate cell DTX for second TRP 906 after a second activation time 964. The second activation time 964 may be later in time than the first activation time 962. Further, the second activation time 954 may be based on an offset (D) from the first activation time 962.

Accordingly, in FIG. 9B, UE 902 changes, at 930, the activation state for cell DTX and/or cell DRX for first TRP 904 at first activation time 962. Further, first TRP 904 changes, at 932, the activation state for cell DTX and/or cell DRX for first TRP 904 at first activation time 952. In this example, UE 902 and first TRP 904 change only an activation state for cell DTX, per the indication received at 926.

Additionally, in FIG. 9B, UE 902 changes, at 934, the activation state for cell DTX and/or cell DRX for second TRP 906 at second activation time 964. Further, second TRP 906 changes, at 936, the activation state for cell DTX and/or cell DRX for second TRP 906 at second activation time 964. In this example, UE 902 and second TRP 906 change only an activation state for cell DTX, per the indication received at 926.

FIGS. 10A and 10B depict example DCI that may be sent to a UE connected to multiple TRPs. For example, FIGS. 10A and 10B depict example DCI that may be sent to UE 902 in FIGS. 9A and 9B from first TRP 904. FIG. 10A provides a first example DCI design, while FIG. 10B provides a second example DCI design.

For example, in FIGS. 10A and 10B, UE 1002 is connected to a first TRP 1004 and a second TRP 1006 of a first cell, Cell A, and connected to a third TRP 1008 and a fourth TRP 1010 of a second cell, Cell B. In FIGS. 10A and 10B, first TRP 1004 sends an indication to UE 1002 via DCI 1011. The indication is associated with first TRP 1004, second TRP 1006, third TRP 1008, and fourth TRP 1010. The indication indicates to change an activation state for cell DTX and/or cell DRX for first TRP 1004, second TRP 1006, third TRP 1008, and/or fourth TRP 1010.

In the first example DCI design in FIG. 10A, DCI 1011 includes multiple blocks of coded bits. Each block of coded bits is associated with a different cell serving UE 902. For example, block 1 in DCI 1011 is associated with Cell A and block K in DCI 1011 is associated with Cell B.

Each block of coded bits includes a set of bits associated with TRP(s) associated with the cell corresponding to the respective block. For example, the set of bits included in block 1, associated with Cell A, are associated with first TRP 1004 and second TRP 1006. Further, the set of bits included in block K, associated with Cell B, are associated with third TRP 1008 and fourth TRP 1010. The set of bits included in block 1 indicates the activation state for cell DTX and/or cell DRX configured for first TRP 1004 and second TRP 1006, while the set of bits included in block K indicates the activation state for cell DTX and/or cell DRX configured for third TRP 1008 and fourth TRP 1010.

For example, in block 1, associated with Cell A, bits “a₁b₁” correspond to first TRP 1004 and bits “c₁d₁” correspond to second TRP 1006. Bits “a₁” and “c₁” may indicate an activation status for cell DTX for first TRP 1004 and second TRP 1006, respectively. For example, where bits a₁ and c₁ are set to “0,” the indication may indicate that cell DTX for first TRP 1004 and second TRP 1006, respectively, is to be deactivated. Alternatively, where bits a₁ and c₁ are set to “1,” the indication may indicate that cell DTX for first TRP 1004 and second TRP 1006, respectively, is to be activated. In certain aspects where the indication indicates that cell DTX is to be activated for first TRP 1004 and/or second TRP 1006 and cell DTX is currently activated for first TRP 1004 and/or second TRP 1006 (e.g., cell DTX was activated prior to receiving DCI 1011), then this activation status may not cause UE 1002 to make any changes (e.g., perform any action for cell DTX for first TRP 1004 and/or second TRP 1006). Alternatively, in certain aspects where the indication indicates that cell DTX is to be activated for first TRP 1004 and/or second TRP 1006 and cell DTX is not currently activated for first TRP 1004 and/or second TRP 1006 (e.g., cell DTX was not activated prior to receiving DCI 1011), then this activation status may cause UE 1002 to activate cell DTX for first TRP 1004 and/or second TRP 1006. The same may be true for cell DRX. Activating cell DTX and/or cell DRX at UE 1002 refers to UE 1002 observing DTX and/or DRX intervals, such as not expecting downlink transmission(s) during DTX inactive intervals and/or not sending uplink transmission(s) during DRX inactive intervals.

Bits “b₁” and “d₁” may indicate an activation status for cell DRX for first TRP 1004 and second TRP 1006, respectively. For example, where bits b₁ and d₁ are set to “0,” the indication may indicate that cell DRX for first TRP 1004 and second TRP 1006, respectively, is to be deactivated. Alternatively, where bits b₁ and d₁ are set to “1,” the indication may indicate that cell DRX for first TRP 1004 and second TRP 1006, respectively, is to be activated.

In block K, associated with Cell B, bits “aₖbₖ” correspond to third TRP 1008 and bits “cₖdₖ” correspond to fourth TRP 1010. Bits “aₖ” and “cₖ” may indicate an activation status for cell DTX for third TRP 1008 and fourth TRP 1010, respectively. For example, where bits aₖ and cₖ are set to “0,” the indication may indicate that cell DTX for third TRP 1008 and fourth TRP 1010, respectively, is to be deactivated. Alternatively, where bits aₖ and cₖ are set to “1,” the indication may indicate that cell DTX for third TRP 1008 and fourth TRP 1010, respectively, is to be activated.

Bits “bₖ” and “dₖ” may indicate an activation status for cell DRX for third TRP 1008 and fourth TRP 1010, respectively. For example, where bits bₖ and dₖ are set to “0,” the indication may indicate that cell DRX for third TRP 1008 and fourth TRP 1010, respectively, is to be deactivated. Alternatively, where bits bₖ and dₖ are set to “1,” the indication may indicate that cell DRX for third TRP 1008 and fourth TRP 1010, respectively, is to be activated.

Unlike the first example DCI design in FIG. 10A where each block in DCI is associated with a different cell and includes bits for TRP(s) associated with the same cell as the block, blocks in second example DCI design in FIG. 10B are each associated with a different TRP connected to UE 1002.

For example, DCI 1011 in FIG. 10B includes multiple blocks of coded bits. Each block of coded bits is associated with a different TRP connected to UE 1002. For example, block 1 in in DCI 1011 is associated first TRP 1004 in Cell A (e.g., the first TRP in Cell A), block K is associated with third TRP 1008 in Cell B (e.g., the first TRP in Cell B), block 1A is associated with second TRP 1006 in Cell A (e.g., the second TRP in Cell A), and block KA is associated with fourth TRP 1010 in Cell B (e.g., the second TRP in Cell B).

The bits in each block are associated with the TRP that the block is associated with. The bits in each block indicate the activation state for cell DTX and/or cell DRX configured for the TRP associated with the respective block. For example, the bits “a₁b₁” in block 1 are bits for first TRP 1004. Bits “a₁” and “b₁” may indicate an activation status for cell DTX and cell DRX for first TRP 1004, respectively. For example, where bit a₁ is set to “0,” the indication may indicate that cell DTX for first TRP 1004 is to be deactivated, and where bit a₁ is set to “1,” the indication may indicate that cell DTX for first TRP 1004 is to be activated. Similarly, where bit b₁ is set to “0,” the indication may indicate that cell DRX for first TRP 1004 is to be deactivated, and where bit b₁ is set to “1,” the indication may indicate that cell DRX for first TRP 1004 is to be activated. In certain aspects where the indication indicates that cell DTX and/or cell DRX is to be activated for first TRP 1004 and cell DTX and/or cell DRX is currently activated for first TRP 1004 (e.g., cell DTX and/or cell DRX was activated prior to receiving DCI 1011), then this activation status may not cause UE 1002 to make any changes (e.g., perform any action for cell DTX and/or cell DRX for first TRP 1004). Alternatively, in certain aspects where the indication indicates that cell DTX and/or cell DRX is to be activated for first TRP 1004 and cell DTX and/or cell DRX is not currently activated for first TRP 1004 (e.g., cell DTX and/or cell DRX was not activated prior to receiving DCI 1011), then this activation status may cause UE 1002 to activate cell DTX and/or cell DRX for first TRP.

FIG. 11 depicts a process flow 1100 for communications in a network between a UE 1102, a first TRP 1104, and a second TRP 1106. In some aspects, the first TRP 1104 and/or the second TRP 1106 may each be a set of (e.g., one or more) geographically co-located antennas at a network entity, such as the BS 102 depicted and described with respect to FIGS. 1 and 3 or a disaggregated base station depicted and described with respect to FIG. 2. The UE 1102 may be an example of UE 104 depicted and described with respect to FIGS. 1 and 3. However, in other aspects, UE 1102 may be another type of wireless communications device and first TRP 1104 and/or second TRP 1106 may be a set of geographically co-located antennas at another type of network entity or network node, such as those described herein. In some aspects, the first TRP 1104 and the second TRP 1106 belong to a same cell or different cells.

Process flow 1100 depicts example techniques used to support cell DTX and/or cell DRX in multiple DCI multiple TRP scenarios (e.g., such as the example scenario depicted and described with respect to FIG. 6A). Thus, in process flow 1100, UE 1102 maintains a connection with first TRP 1104 and second TRP 1106, and may receive signaling indicating two CORESET groups that UE 1102 is configured to monitor for DCI. A first CORESET group may correspond to first TRP 1104 and a second CORESET group may correspond to second TRP 1106.

Although process flow 1100 is described with respect to a UE being simultaneously connected to two TRPs, e.g., first TRP 1104 and second TRP 1106, the operations in process flow 1100 may be similarly applied in cases where a UE has established a connection with more than two TRPs.

Process flow 1100 in FIG. 11 begins at 1108 with UE 1102 being configured with two CORESETs. A first CORESET group may correspond to first TRP 1104 and a second CORESET group may correspond to second TRP 1106. Thus, UE 1102 may have an established connection with a plurality of TRPs, and more specifically, first TRP 1104 and second TRP 1106. Because UE 1102 receives signaling indicating that UE 1102 is to monitor two different CORESET groups, UE 1102 may be configured to monitor transmissions from both first TRP 1104 and second TRP 1106. For example, UE 1102 may receive multiple DCI by monitoring both CORESETs.

For example, at 1110, based on monitoring for DCI in the first CORESET, UE 1102 may receive DCI from first TRP 1104. The received DCI may carry an indication associated with only first TRP 1104. The indication may indicate to change an activation state for cell DRX and/or cell DRX for only the first TRP 1104. An indication to change an activation state for cell DTX may include an indication to (1) activate cell DTX when cell DTX is currently deactivated or (2) deactivate cell DTX when cell DTX is currently activated. Similarly, an indication to change an activation state for cell DRX may include an indication to (1) activate cell DRX when cell DRX is currently deactivated or (2) deactivate cell DRX when cell DRX is currently activated.

In this example depicted in FIG. 11, the indication received by UE 1102, at 1110 (e.g., via DCI), may indicate to change an activation status for only cell DTX at first TRP 1104. For example, in this example, prior to receiving the indication, cell DTX may have been deactivated for first TRP 1104. Thus, based on receiving the indication at 1110, UE 1102 may activate cell DTX for first TRP 1104. Specifically, UE 1102 may activate cell DTX for first TRP 1104 after a first activation time 1152, which may be a time period X (e.g., 3 ms) after receiving the indication at 1110 (and other offset values in other examples).

UE 1102 changes, at 1112, the activation state for cell DTX and/or cell DRX for first TRP 1104 at first activation time 1152. Further, first TRP 1104 changes, at 1114, the activation state for cell DTX and/or cell DRX for first TRP 1104 at first activation time 1152. In this example, UE 1102 and first TRP 1104 change only an activation state for cell DTX, per the indication received at 1110.

Further, at 1116, based on monitoring for DCI in the second CORESET, UE 1102 may receive DCI from second TRP 1106. The received DCI may carry an indication associated with only second TRP 1106. The indication may indicate to change an activation state for cell DRX and/or cell DRX for only the second TRP 1106.

In this example depicted in FIG. 11, the indication received by UE 1102, at 1110 (e.g., via DCI), may indicate to change an activation status for only cell DTX at second TRP 1106. For example, in this example, prior to receiving the indication, cell DTX may have been deactivated for second TRP 1106. Thus, based on receiving the indication at 1116, UE 1102 may activate cell DTX for second TRP 1106. Specifically, UE 1102 may activate cell DTX for second TRP 1106 after a second activation time 1154, which may be 3 ms after receiving the indication at 1116 (and other offset values in other examples).

UE 1102 changes, at 1118, the activation state for cell DTX and/or cell DRX for second TRP 1106 at second activation time 1154. Further, second TRP 1106 changes, at 1120, the activation state for cell DTX and/or cell DRX for second TRP 1106 at second activation time 1154. In this example, UE 1102 and second TRP 1106 change only an activation state for cell DTX, per the indication received at 1116.

Although FIG. 11 describes a scenario where the indication per TRP to change an activation status for cell DTX and/or cell DRX at a respective TRP is sent/received via DCI, in some other cases, the indication per TRP is sent/received via RRC signaling. For example, first RRC signaling from first TRP 1104 may include an indication to change an activation status for cell DTX and/or cell DRX at first TRP 1104. Further, second RRC signaling from second TRP 1106 may include an indication to change an activation status for cell DTX and/or cell DRX at second TRP 1106.

### Example Operations for Cell DTX and/or DRX Control for Multiple TRPs

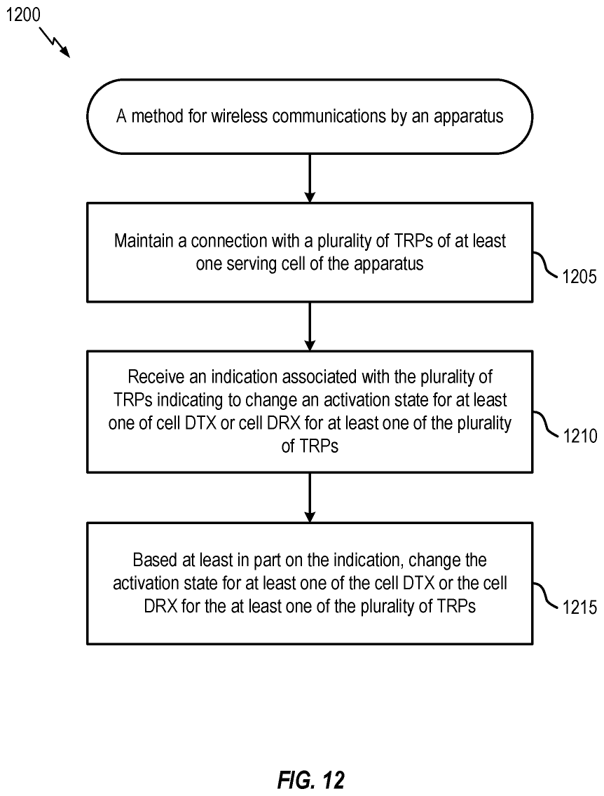

FIG. 12 shows a method 1200 for wireless communications by an apparatus, such as UE 104 of FIGS. 1 and 3.

Method 1200 begins at block 1205 with maintaining a connection with a plurality of TRPs of at least one serving cell of the apparatus.

Method 1200 then proceeds to block 1210 with receiving an indication associated with the plurality of TRPs indicating to change an activation state for at least one of cell DTX or cell DRX for at least one of the plurality of TRPs.

Method 1200 then proceeds to block 1215 with, based at least in part on the indication, changing the activation state for at least one of the cell DTX or the cell DRX for the at least one of the plurality of TRPs.

In certain aspects, receiving the indication comprises receiving the indication from a first TRP of the plurality of TRPs without receiving the indication from the other TRPs of the plurality of TRPs based at least in part on a configuration.

In certain aspects, maintaining the connection with the plurality of TRPs comprises receiving signaling indicating a plurality of CORESET groups that the apparatus is configured to monitor for DCI, each CORESET group corresponding to one of the plurality of TRPs, and the method 1200 further comprises monitoring only a first CORESET group of the plurality of CORESET groups for the indication, the first CORESET group corresponding to the first TRP of the plurality of TRPs.

In certain aspects, monitoring only the first CORESET group of the plurality of CORESET groups for the indication comprises monitoring a first search space associated with the first CORESET group and associated with a PDCCH.

In certain aspects, the indication indicates to change the activation state for at least one of the cell DTX or the cell DRX for the first TRP and at least one of the other TRPs. In certain aspects, block 1215 includes: changing the activation state for at least one of the cell DTX or the cell DRX for the first TRP after a first activation time occurring after receiving the indication; and changing the activation state for at least one of the cell DTX or the cell DRX for at least one of the other TRPs after a second activation time occurring after the first activation time.

In certain aspects, the second activation time is based at least in part on an offset from the first activation time.

In certain aspects, the plurality of TRPs are associated with a single serving cell, the indication comprises one block of coded bits, the block of coded bits comprises a set of bits associated with each of the plurality of TRPs, and each set of bits indicates the activation state for at least one of the cell DTX or the cell DRX configured for the corresponding TRP.

In certain aspects, the plurality of TRPs are associated with a plurality of serving cells, the indication comprises a plurality of blocks of coded bits, each block of coded bits is associated with one serving cell of the plurality of serving cells; each block of coded bits comprises a set of bits associated with each TRP of the plurality of TRPs associated with the serving cell associated with the corresponding block; and each set of bits indicates the activation state for at least one of the cell DTX or the cell DRX configured for the corresponding TRP.

In certain aspects, the indication comprises a plurality of blocks of coded bits, each block of coded bits comprises a set of bits associated with one TRP of the plurality of TRPs, and each set of bits indicates the activation state for at least one of the cell DTX or the cell DRX configured for the corresponding TRP.

In certain aspects, block 1210 includes receiving the indication via a DCI.

In certain aspects, block 1205 includes receiving signaling indicating at least two activated TCI states for the at least one serving cell of the apparatus, each activated TCI state corresponding to one of the plurality of TRPs.

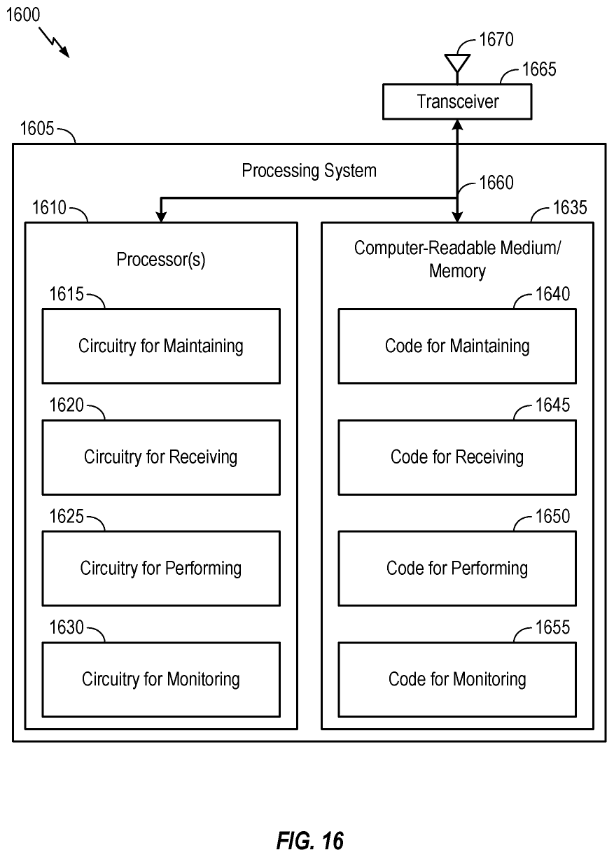

In certain aspects, method 1200, or any aspect related to it, may be performed by an apparatus, such as communications device 1600 of FIG. 16, which includes various components operable, configured, or adapted to perform the method 1200. Communications device 1600 is described below in further detail.

Note that FIG. 12 is just one example of a method, and other methods including fewer, additional, or alternative operations are possible consistent with this disclosure.

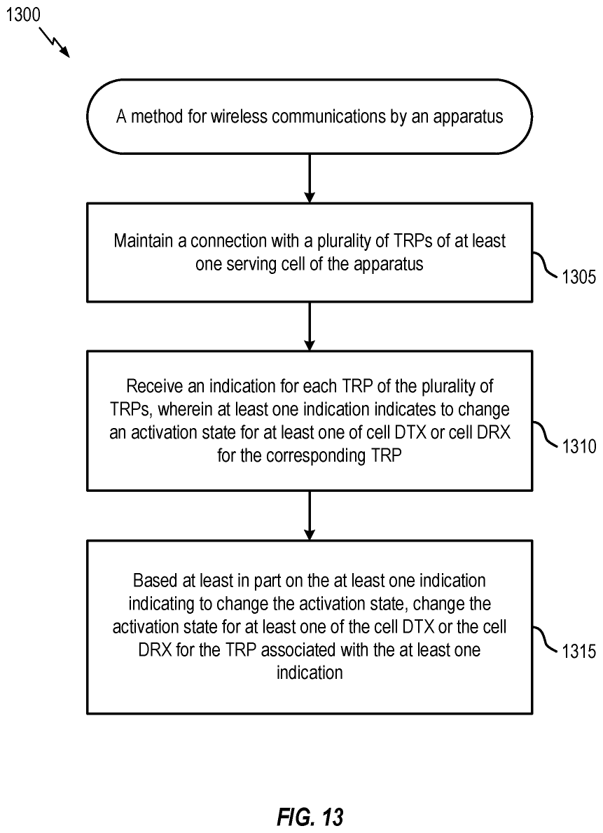

FIG. 13 shows a method 1300 for wireless communications by an apparatus, such as UE 104 of FIGS. 1 and 3.

Method 1300 begins at block 1305 with maintaining a connection with a plurality of TRPs of at least one serving cell of the apparatus.

Method 1300 then proceeds to block 1310 with receiving an indication for each TRP of the plurality of TRPs, wherein at least one indication indicates to change an activation state for at least one of cell DTX or cell DRX for the corresponding TRP.

Method 1300 then proceeds to block 1315 with, based at least in part on the at least one indication indicating to change the activation state, changing the activation state for at least one of the cell DTX or the cell DRX for the TRP associated with the at least one indication.

In certain aspects, block 1310 includes: receiving, at a first reception time, a first indication for a first TRP of the plurality of TRPs indicating to change the activation state for at least one of the cell DTX or the cell DRX for the first TRP; and receiving, at a second reception time, a second indication for a second TRP of the plurality of TRPs indicating to change the activation state for at least one of the cell DTX or the cell DRX for the second TRP. In certain aspects, block 1315 includes: changing the activation state for at least one of the cell DTX or the cell DRX for the first TRP after a first activation time based at least in part on an offset from the first reception time; and changing the activation state for at least one of the cell DTX or the cell DRX for the second TRP after a second activation time based at least in part on the offset from the second reception time.

In certain aspects, block 1305 includes receiving signaling indicating a plurality of CORESET groups that the apparatus is configured to monitor for DCI, each CORESET group corresponding to one of the plurality of TRPs, and the method 1300 further comprises monitoring for the indication for each TRP of the plurality of TRPs in the CORESET group corresponding to each TRP.

In certain aspects, block 1310 includes receiving the indication for each TRP via a DCI.

In certain aspects, block 1310 includes receiving the indication for each TRP via RRC signaling.

In certain aspects, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative operations are possible consistent with this disclosure.

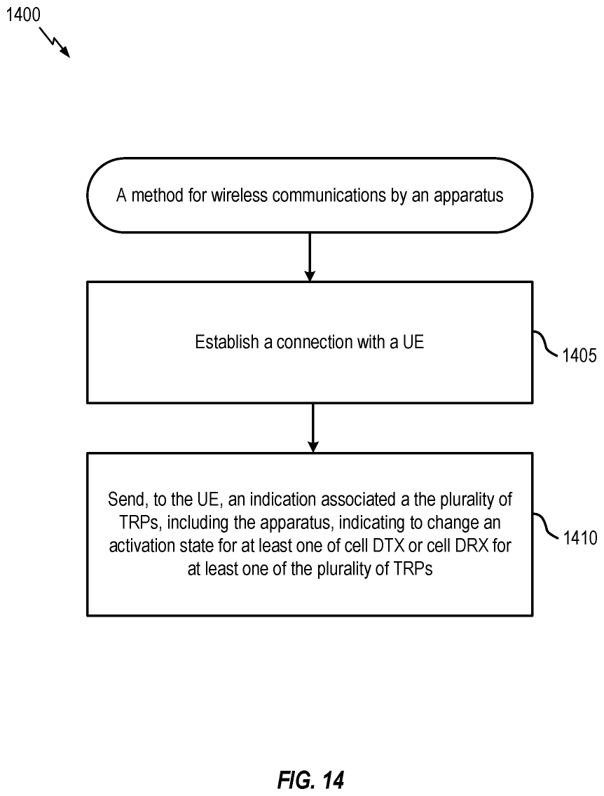

FIG. 14 shows a method 1400 for wireless communications by an apparatus, such as TRP of a network entity, such as BS 102 of FIGS. 1 and 3, or a disaggregated base station as discussed with respect to FIG. 2.

Method 1400 begins at block 1405 with establishing a connection with a UE.

Method 1400 then proceeds to block 1410 with sending, to the UE, an indication associated with a plurality of TRPs, including the apparatus, indicating to change an activation state for at least one of cell DTX or cell DRX for at least one of the plurality of TRPs.

In certain aspects, the indication indicates to change the activation state for at least one of the cell DTX or the cell DRX for the apparatus, and the method 1400 further comprises changing the activation state for at least one of the cell DTX or the cell DRX for the apparatus based at least in part on the indication.

In certain aspects, changing the activation state for at least one of the cell DTX or the cell DRX for the apparatus includes changing the activation state for at least one of the cell DTX or the cell DRX for the apparatus after an activation time occurring after sending the indication.

In certain aspects, the method 1400 further includes sending, to at least the other TRP of the plurality of TRPs, a message indicating to change at least one of the cell DTX or the cell DRX for the other TRP.

In certain aspects, the method 1400 further includes receiving, from a TRP of the plurality of TRPs, a second indication associated with the plurality of TRPs indicating to change at least one of the cell DTX or the cell DRX at the apparatus and changing the activation state for at least one of the cell DTX or the cell DRX for the apparatus based at least in part on the second indication.

In certain aspects, the plurality of TRPs, including the apparatus, are associated with a single serving cell, the indication comprises one block of coded bits, the block of coded bits comprises a set of bits associated with each of the plurality of TRPs, and each set of bits indicates the activation state for at least one of the cell DTX or the cell DRX configured for the corresponding TRP.

In certain aspects, the plurality of TRPs, including the apparatus, are associated with a plurality of serving cells, the indication comprises a plurality of blocks of coded bits, each block of coded bits is associated with one serving cell of the plurality of serving cells; each block of coded bits comprises a set of bits associated with each TRP of the plurality of TRPs associated with the serving cell associated with the corresponding block; and each set of bits indicates the activation state for at least one of the cell DTX or the cell DRX configured for the corresponding TRP.

In certain aspects, the indication comprises a plurality of blocks of coded bits, each block of coded bits comprises a set of bits associated with one TRP of the plurality of TRPs, including the apparatus, and each set of bits indicates the activation state for at least one of the cell DTX or the cell DRX configured for the corresponding TRP.

In certain aspects, block 1410 includes sending the indication via a DCI.

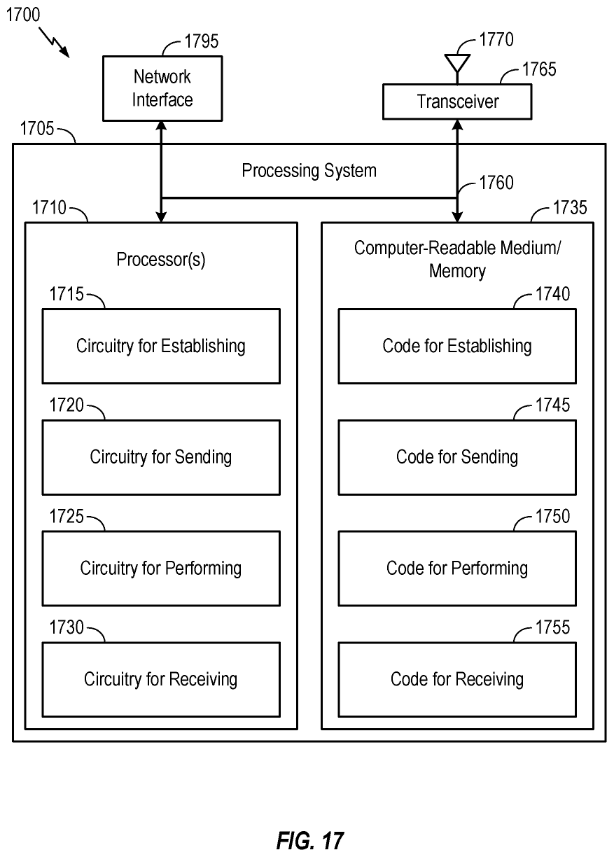

In certain aspects, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative operations are possible consistent with this disclosure.

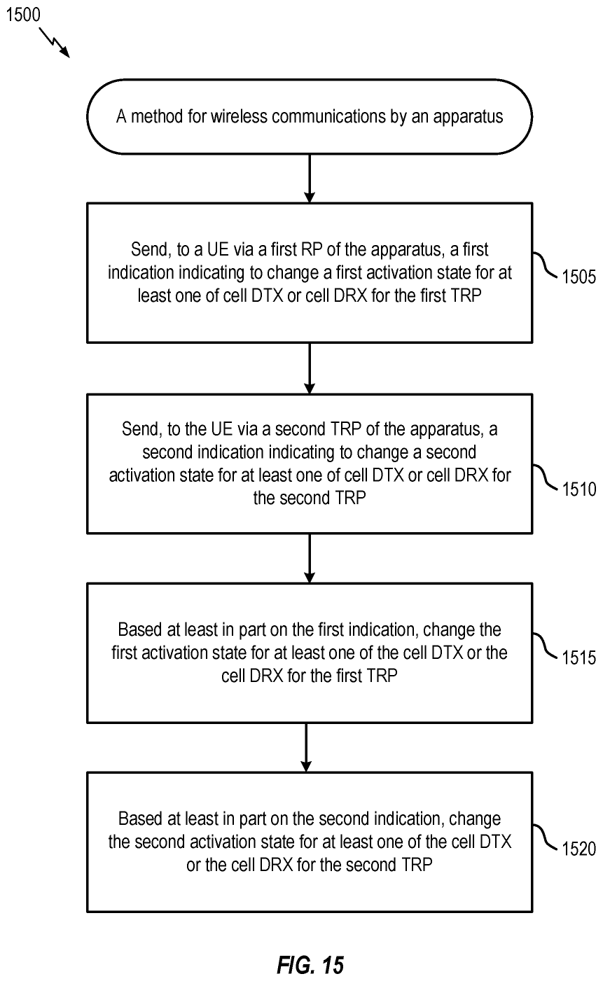

FIG. 15 shows a method 1500 for wireless communications by an apparatus, such as TRP of a network entity, such as BS 102 of FIGS. 1 and 3, or a disaggregated base station as discussed with respect to FIG. 2.

Method 1500 begins at block 1505 with sending, to a UE via a first TRP of the apparatus, a first indication indicating to change a first activation state for at least one of cell DTX or cell DRX for the first TRP.

Method 1500 then proceeds to block 1510 with sending, to the UE via a second TRP of the apparatus, a second indication indicating to change a second activation state for at least one of the cell DTX or the cell DRX for the second TRP.

Method 1500 then proceeds to block 1515 with, based at least in part on the first indication, changing the first activation state for at least one of the cell DTX or the cell DRX for the first TRP.

Method 1500 then proceeds to block 1520 with, based at least in part on the second indication, changing the second activation state for at least one of the cell DTX or the cell DRX for the second TRP.

In certain aspects, block 1505 includes sending the first indication via DCI.

In certain aspects, block 1510 includes sending the second indication via DCI.

In certain aspects, block 1505 includes sending the first indication via RRC signaling.

In certain aspects, block 1510 includes sending the second indication via RRC signaling.

In certain aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Device

FIG. 16 depicts aspects of an example communications device 1600. In some aspects, communications device 1600 is a user equipment, such as UE 104 described above with respect to FIGS. 1 and 3.

The communications device 1600 includes a processing system 1605 coupled to a transceiver 1665 (e.g., a transmitter and/or a receiver). The transceiver 1665 is configured to transmit and receive signals for the communications device 1600 via an antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, enable and cause the one or more processors 1610 to perform the method 1200 described with respect to FIG. 12, or any aspect related to it, including any operations described in relation to FIG. 12; and the method 1300 described with respect to FIG. 13, or any aspect related to it, including any operations described in relation to FIG. 13. Note that reference to a processor performing a function of communications device 1600 may include one or more processors performing that function of communications device 1600, such as in a distributed fashion.

In the depicted example, computer-readable medium/memory 1635 stores code for maintaining 1640, code for receiving 1645, code for performing 1650, and code for monitoring 1655. Processing of the code 1640-1655 may enable and cause the communications device 1600 to perform the method 1200 described with respect to FIG. 12, or any aspect related to it; and the method 1300 described with respect to FIG. 13, or any aspect related to it.

The one or more processors 1610 include circuitry configured to implement (e.g., execute) the code stored in the computer-readable medium/memory 1635, including circuitry for maintaining 1615, circuitry for receiving 1620, circuitry for performing 1625, and circuitry for monitoring 1630. Processing with circuitry 1615-1630 may enable and cause the communications device 1600 to perform the method 1200 described with respect to FIG. 12, or any aspect related to it; and the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1465 and/or antenna 1670 of the communications device 1600 in FIG. 16, and/or one or more processors 1610 of the communications device 1600 in FIG. 16. Means for communicating, receiving or obtaining may include the transceivers 354, antenna(s) 352, receive processor 358, AI processor 370, and/or controller/processor 380 of the UE 104 illustrated in FIG. 3, transceiver 1665 and/or antenna 1670 of the communications device 1600 in FIG. 16, and/or one or more processors 1610 of the communications device 1600 in FIG. 16.

FIG. 17 depicts aspects of an example communications device 1700. In some aspects, communications device 1700 is a TRP of a network entity, such as BS 102 of FIGS. 1 and 3, or a disaggregated base station as discussed with respect to FIG. 2.

The communications device 1700 includes a processing system 1705 coupled to a transceiver 1765 (e.g., a transmitter and/or a receiver) and/or a network interface 1795. The transceiver 1765 is configured to transmit and receive signals for the communications device 1700 via an antenna 1770, such as the various signals as described herein. The network interface 1795 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1735 via a bus 1760. In certain aspects, the computer-readable medium/memory 1735 is configured to store instructions (e.g., computer-executable code) that when executed by the one or more processors 1710, enable and cause the one or more processors 1710 to perform the method 1400 described with respect to FIG. 14, or any aspect related to it, including any operations described in relation to FIG. 14; and the method 1500 described with respect to FIG. 15, or any aspect related to it, including any operations described in relation to FIG. 15. Note that reference to a processor of communications device 1700 performing a function may include one or more processors of communications device 1700 performing that function, such as in a distributed fashion.

In the depicted example, the computer-readable medium/memory 1735 stores code for establishing 1740, code for sending 1745, code for performing 1750, and code for receiving 1755. Processing of the code 1740-1755 may enable and cause the communications device 1700 to perform the method 1400 described with respect to FIG. 14, or any aspect related to it; and method 1500 described with respect to FIG. 15, or any aspect related to it.

The one or more processors 1710 include circuitry configured to implement (e.g., execute) the code stored in the computer-readable medium/memory 1735, including circuitry for establishing 1715, circuitry for sending 1720, circuitry for performing 1725, and circuitry for receiving 1730. Processing with circuitry 1715-1730 may enable and cause the communications device 1700 to perform the method 1400 described with respect to FIG. 14, or any aspect related to it; and method 1500 described with respect to FIG. 15, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1765, antenna 1770, and/or network interface 1795 of the communications device 1700 in FIG. 17, and/or one or more processors 1710 of the communications device 1700 in FIG. 17. Means for communicating, receiving or obtaining may include the transceivers 332, antenna(s) 334, receive processor 338, AI processor 318, and/or controller/processor 340 of the BS 102 illustrated in FIG. 3, transceiver 1765, antenna 1770, and/or network interface 1795 of the communications device 1700 in FIG. 17, and/or one or more processors 1710 of the communications device 1700 in FIG. 17.

### EXAMPLE CLAUSES

Implementation examples are described in the following numbered clauses:

Clause 1: A method for wireless communications by an apparatus comprising: maintaining a connection with a plurality of TRPs of at least one serving cell of the apparatus; receiving an indication associated with the plurality of TRPs indicating to change an activation state for at least one of cell DTX or cell DRX for at least one of the plurality of TRPs; and based at least in part on the indication, changing the activation state for at least one of the cell DTX or the cell DRX for the at least one of the plurality of TRPs.

Clause 2: The method of Clause 1, wherein receiving the indication comprises receiving the indication from a first TRP of the plurality of TRPs without receiving the indication from the other TRPs of the plurality of TRPs based at least in part on a configuration.

Clause 3: The method of Clause 2, wherein: maintaining the connection with the plurality of TRPs comprises receiving signaling indicating a plurality of CORESET groups that the apparatus is configured to monitor for DCI, each CORESET group corresponding to one of the plurality of TRPs, and the method further comprises monitoring only a first CORESET group of the plurality of CORESET groups for the indication, the first CORESET group corresponding to the first TRP of the plurality of TRPs.

Clause 4: The method of Clause 3, wherein monitoring only the first CORESET group of the plurality of CORESET groups for the indication comprises monitoring a first search space associated with the first CORESET group and associated with a PDCCH.

Clause 5: The method of Clause 2, wherein: the indication indicates to change the activation state for at least one of the cell DTX or the cell DRX for the first TRP and at least one of the other TRPs, and changing the activation state for at least one of the cell DTX or the cell DRX for at least one of the plurality of TRPs, comprises: changing the activation state for at least one of the cell DTX or the cell DRX for the first TRP after a first activation time occurring after reception of the indication; and changing the activation state for at least one of the cell DTX or the cell DRX for at least one of the other TRPs after a second activation time occurring after the first activation time.

Clause 6: The method of Clause 5, wherein the second activation time is based at least in part on an offset from the first activation time.

Clause 7: The method of any one of Clauses 1-6, wherein: the plurality of TRPs are associated with a single serving cell, the indication comprises one block of coded bits, the block of coded bits comprises a set of bits associated with each of the plurality of TRPs, and each set of bits indicates the activation state for at least one of the cell DTX or the cell DRX configured for the corresponding TRP.

Clause 8: The method of any one of Clauses 1-7, wherein: the plurality of TRPs are associated with a plurality of serving cells, the indication comprises a plurality of blocks of coded bits, each block of coded bits is associated with one serving cell of the plurality of serving cells; each block of coded bits comprises a set of bits associated with each TRP of the plurality of TRPs associated with the serving cell associated with the corresponding block; and each set of bits indicates the activation state for at least one of the cell DTX or the cell DRX configured for the corresponding TRP.

Clause 9: The method of any one of Clauses 1-8, wherein: the indication comprises a plurality of blocks of coded bits, each block of coded bits comprises a set of bits associated with one TRP of the plurality of TRPs, and each set of bits indicates the activation state for at least one of the cell DTX or the cell DRX configured for the corresponding TRP.

Clause 10: The method of any one of Clauses 1-9, wherein receiving the indication comprises receiving the indication via downlink control information (DCI).

Clause 11: The method of any one of Clauses 1-10, wherein maintaining the connection with the plurality of TRPs comprises receiving signaling indicating at least two activated TCI states for the at least one serving cell of the apparatus, each activated TCI state corresponding to one of the plurality of TRPs.

Clause 12: A method for wireless communications by an apparatus comprising: maintaining a connection with a plurality of TRPs of at least one serving cell of the apparatus; receiving an indication for each TRP of the plurality of TRPs, wherein at least one indication indicates to change an activation state for at least one of cell DTX or cell DRX for the corresponding TRP; and based at least in part on the at least one indication indicating to change the activation state, changing the activation state for at least one of the cell DTX or the cell DRX for the TRP associated with the at least one indication.

Clause 13: The method of Clause 12, wherein: receiving the indication for each TRP comprises: receiving, at a first reception time, a first indication for a first TRP of the plurality of TRPs indicating to change the activation state for at least one of the cell DTX or the cell DRX for the first TRP; receiving, at a second reception time, a second indication for a second TRP of the plurality of TRPs indicating to change the activation state for at least one of the cell DTX or the cell DRX for the second TRP; and changing the activation state for at least one of the cell DTX or the cell DRX for the TRP associated with the at least one indication, comprises: changing the activation state for at least one of the cell DTX or the cell DRX for the first TRP after a first activation time based at least in part on an offset from the first reception time; and changing the activation state for at least one of the cell DTX or the cell DRX for the second TRP after a second activation time based at least in part on the offset from the second reception time.

Clause 14: The method of any one of Clauses 12-13, wherein: maintaining the connection with the plurality of TRPs comprises receiving signaling indicating a plurality of CORESET groups that the apparatus is configured to monitor for DCI, each CORESET group corresponding to one of the plurality of TRPs, and the method further comprises monitoring for the indication for each TRP of the plurality of TRPs in the CORESET group corresponding to each TRP.

Clause 15: The method of any one of Clauses 12-14, wherein receiving the indication for each TRP comprises receiving the indication for each TRP via a DCI.

Clause 16: The method of any one of Clauses 12-15, wherein receiving the indication for each TRP comprises receiving the indication for each TRP via RRC signaling.

Clause 17: A method for wireless communications by an apparatus comprising: establishing a connection with a user equipment (UE); and sending, to the UE, an indication associated a the plurality of transmission reception points (TRPs), including the apparatus, indicating to change an activation state for at least one of cell DTX or cell DRX for at least one of the plurality of TRPs.

Clause 18: The method of Clause 17, wherein: the indication indicates to change the activation state for at least one of the cell DTX or the cell DRX for the apparatus; and the method further comprises changing the activation state for at least one of the cell DTX or the cell DRX for the apparatus based at least in part on the indication.

Clause 19: The method of Clause 18, wherein changing the activation state for at least one of the cell DTX or the cell DRX for the apparatus comprises changing the activation state for at least one of the cell DTX or the cell DRX for the apparatus after an activation time occurring after sending the indication.

Clause 20: The method of any one of Clauses 18-19, wherein the indication further indicates to change the activation state for at least one of the cell DTX or the cell DRX for at least one other TRP of the plurality of TRPs and the method further comprises coordinating with at least the one other TRP of the plurality of TRPs via backhaul to indicate to at least the one other TRP to change at least one of the cell DTX or the cell DRX.

Clause 21: The method of any one of Clauses 17-20, further comprising: coordinating with a TRP of the plurality of TRPs via backhaul to receive a second indication associated with the plurality of TRPs indicating to change at least one of the cell DTX or the cell DRX at the apparatus; and changing the activation state for at least one of the cell DTX or the cell DRX for the apparatus based at least in part on the second indication.

Clause 22: The method of any one of Clauses 17-21, wherein: the plurality of TRPs, including the apparatus, are associated with a single serving cell, the indication comprises one block of coded bits, the block of coded bits comprises a set of bits associated with each of the plurality of TRPs, and each set of bits indicates the activation state for at least one of the cell DTX or the cell DRX configured for the corresponding TRP.

Clause 23: The method of any one of Clauses 17-22, wherein: the plurality of TRPs, including the apparatus, are associated with a plurality of serving cells, the indication comprises a plurality of blocks of coded bits, each block of coded bits is associated with one serving cell of the plurality of serving cells; each block of coded bits comprises a set of bits associated with each TRP of the plurality of TRPs associated with the serving cell associated with the corresponding block; and each set of bits indicates the activation state for at least one of the cell DTX or the cell DRX configured for the corresponding TRP.

Clause 24: The method of any one of Clauses 17-23, wherein: the indication comprises a plurality of blocks of coded bits, each block of coded bits comprises a set of bits associated with one TRP of the plurality of TRPs, including the apparatus, and each set of bits indicates the activation state for at least one of the cell DTX or the cell DRX configured for the corresponding TRP.

Clause 25: The method of any one of Clauses 17-24, wherein the apparatus sends the indication via downlink control information (DCI).

Clause 26: A method for wireless communications by an apparatus comprising: sending, to a user equipment (UE) via a first transmission reception point (TRP) of the apparatus, an indication indicating to change a first activation state for at least one of cell discontinuous transmission (DTX) or cell discontinuous reception (DRX) for the first TRP; sending, to the UE via a second TRP of the apparatus, a second indication indicating to change a second activation state for at least one of the cell DTX or the cell DRX for the second TRP; based at least in part on the first indication, changing the first activation state for at least one of the cell DTX or the cell DRX for the first TRP; and based at least in part on the second indication, changing the second activation state for at least one of the cell DTX or the cell DRX for the second TRP.

Clause 27: The method of Clause 26, wherein the apparatus sends, to the UE, at least one of the first indication or the second indication via downlink control information (DCI).

Clause 28: The method of Clause 26, wherein the apparatus sends, to the UE, at least one of the first indication or the second indication via radio resource control (RRC) signaling.

Clause 29: One or more apparatuses, comprising: one or more memories comprising executable instructions and one or more processors configured to execute the executable instructions and cause the one or more apparatuses to perform a method in accordance with any one of Clauses 1-28.

Clause 30: One or more apparatuses, comprising: one or more memories and one or more processors, coupled to the one or more memories, configured to cause the one or more apparatuses to perform a method in accordance with any one of Clauses 1-28.

Clause 31: One or more apparatuses, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

Clause 35: A UE, comprising: a processing system that includes processor circuitry and memory circuitry that stores code and is coupled with the processor circuitry, the processing system configured to cause the UE to perform a method in accordance with any one of Clauses 1-16.

Clause 36: A network entity, comprising: a processing system that includes processor circuitry and memory circuitry that stores code and is coupled with the processor circuitry, the processing system configured to cause the network entity to perform a method in accordance with any one of Clauses 17-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
maintain a connection with a plurality of transmission reception points (TRPs) of at least one serving cell of the apparatus;
receive an indication associated with the plurality of TRPs indicating to change an activation state for at least one of cell discontinuous transmission (DTX) or cell discontinuous reception (DRX) for at least one of the plurality of TRPs; and
based at least in part on the indication, change the activation state for at least one of the cell DTX or the cell DRX for the at least one of the plurality of TRPs.

2. The apparatus of claim 1, wherein to receive the indication, the one or more processors are configured to cause the apparatus to receive the indication from a first TRP of the plurality of TRPs without receiving the indication from the other TRPs of the plurality of TRPs based at least in part on a configuration.

3. The apparatus of claim 2, wherein:
to maintain the connection with the plurality of TRPs, the one or more processors are configured to cause the apparatus to receive signaling indicating a plurality of control resource set (CORESET) groups that the apparatus is configured to monitor for downlink control information (DCI), each CORESET group corresponding to one of the plurality of TRPs, and
the one or more processors are configured to cause the apparatus to monitor only a first CORESET group of the plurality of CORESET groups for the indication, the first CORESET group corresponding to the first TRP of the plurality of TRPs.

4. The apparatus of claim 3, wherein to monitor only the first CORESET group of the plurality of CORESET groups for the indication, the one or more processors are configured to cause the apparatus to monitor a first search space associated with the first CORESET group and associated with a physical downlink control channel (PDCCH).

5. The apparatus of claim 2, wherein:
the indication indicates to change the activation state for at least one of the cell DTX or the cell DRX for the first TRP and at least one of the other TRPs, and
to change the activation state for at least one of the cell DTX or the cell DRX for at least one of the plurality of TRPs, the one or more processors are configured to cause the apparatus to:
change the activation state for at least one of the cell DTX or the cell DRX for the first TRP after a first activation time occurring after reception of the indication; and
change the activation state for at least one of the cell DTX or the cell DRX for at least one of the other TRPs after a second activation time occurring after the first activation time.

6. The apparatus of claim 5, wherein the second activation time is based at least in part on an offset from the first activation time.

7. The apparatus of claim 1, wherein:
the plurality of TRPs are associated with a single serving cell,
the indication comprises one block of coded bits,
the block of coded bits comprises a set of bits associated with each of the plurality of TRPs, and
each set of bits indicates the activation state for at least one of the cell DTX or the cell DRX configured for the corresponding TRP.

8. The apparatus of claim 1, wherein:
the plurality of TRPs are associated with a plurality of serving cells,
the indication comprises a plurality of blocks of coded bits,
each block of coded bits is associated with one serving cell of the plurality of serving cells;
each block of coded bits comprises a set of bits associated with each TRP of the plurality of TRPs associated with the serving cell associated with the corresponding block; and
each set of bits indicates the activation state for at least one of the cell DTX or the cell DRX configured for the corresponding TRP.

9. The apparatus of claim 1, wherein:
the indication comprises a plurality of blocks of coded bits,
each block of coded bits comprises a set of bits associated with one TRP of the plurality of TRPs, and
each set of bits indicates the activation state for at least one of the cell DTX or the cell DRX configured for the corresponding TRP.

10. The apparatus of claim 1, wherein to receive the indication the one or more processors are configured to cause the apparatus to receive the indication via downlink control information (DCI).

11. The apparatus of claim 1, wherein to maintain the connection with the plurality of TRPs, the one or more processors are configured to cause the apparatus to receive signaling indicating at least two activated transmission configuration indicator (TCI) states for the at least one serving cell of the apparatus, each activated TCI state corresponding to one of the plurality of TRPs.

12. An apparatus configured for wireless communications, comprising:
one or more memories; and
one or more processors coupled to the one or more memories, the one or more processors being configured to cause the apparatus to:
maintain a connection with a plurality of transmission reception points (TRPs) of at least one serving cell of the apparatus;
receive an indication for each TRP of the plurality of TRPs, wherein at least one indication indicates to change an activation state for at least one of cell discontinuous transmission (DTX) or cell discontinuous reception (DRX) for the corresponding TRP; and
based at least in part on the at least one indication indicating to change the activation state, change the activation state for at least one of the cell DTX or the cell DRX for the TRP associated with the at least one indication.

13. The apparatus of claim 12, wherein:
to receive the indication for each TRP, the one or more processors are configured to cause the apparatus to:
receive, at a first reception time, a first indication for a first TRP of the plurality of TRPs indicating to change the activation state for at least one of the cell DTX or the cell DRX for the first TRP;
receive, at a second reception time, a second indication for a second TRP of the plurality of TRPs indicating to change the activation state for at least one of the cell DTX or the cell DRX for the second TRP; and
to change the activation state for at least one of the cell DTX or the cell DRX for the TRP associated with the at least one indication, the one or more processors are configured to cause the apparatus to:
change the activation state for at least one of the cell DTX or the cell DRX for the first TRP after a first activation time based at least in part on an offset from the first reception time; and
change the activation state for at least one of the cell DTX or the cell DRX for the second TRP after a second activation time based at least in part on the offset from the second reception time.

14. The apparatus of claim 12, wherein:
to maintain the connection with the plurality of TRPs, the one or more processors are configured to cause the apparatus to receive signaling indicating a plurality of control resource set (CORESET) groups that the apparatus is configured to monitor for downlink control information (DCI), each CORESET group corresponding to one of the plurality of TRPs, and
the one or more processors are configured to cause the apparatus to monitor for the indication for each TRP of the plurality of TRPs in the CORESET group corresponding to each TRP.

15. The apparatus of claim 12, wherein to receive the indication for each TRP, the one or more processors are configured to cause the apparatus to receive the indication for each TRP via downlink control information (DCI).

16. The apparatus of claim 12, wherein to receive the indication for each TRP, the one or more processors are configured to cause the apparatus to receive the indication for each TRP via radio resource control (RRC) signaling.

17. An apparatus configured for wireless communications, comprising:
one or more memories; and
one or more processors coupled to the one or more memories, the one or more processors being configured to cause the apparatus to:
establish a connection with a user equipment (UE); and
send, to the UE, an indication associated with a plurality of transmission reception points (TRPs), including the apparatus, indicating to change an activation state for at least one of cell discontinuous transmission (DTX) or cell discontinuous reception (DRX) for at least one of the plurality of TRPs.

18. The apparatus of claim 17, wherein:
the indication indicates to change the activation state for at least one of the cell DTX or the cell DRX for the apparatus; and
the one or more processors are configured to cause the apparatus to change the activation state for at least one of the cell DTX or the cell DRX for the apparatus based at least in part on the indication.

19. The apparatus of claim 18, wherein to change the activation state for at least one of the cell DTX or the cell DRX for the apparatus, the one or more processors are configured to cause the apparatus to change the activation state for at least one of the cell DTX or the cell DRX for the apparatus after an activation time occurring after sending the indication.

20. The apparatus of claim 18, wherein:
the indication further indicates to change the activation state for at least one of the cell DTX or the cell DRX for at least one other TRP of the plurality of TRPs; and
the one or more processors are configured to cause the apparatus to coordinate with at least the one other TRP of the plurality of TRPs via backhaul to indicate to at least the one other TRP to change at least one of the cell DTX or the cell DRX.

21. The apparatus of claim 17, wherein the one or more processors are configured to cause the apparatus to:
coordinate with a TRP of the plurality of TRPs via backhaul to receive a second indication associated with the plurality of TRPs indicating to change at least one of the cell DTX or the cell DRX at the apparatus; and
change the activation state for at least one of the cell DTX or the cell DRX for the apparatus based at least in part on the second indication.

22. The apparatus of claim 17, wherein:
the plurality of TRPs, including the apparatus, are associated with a single serving cell,
the indication comprises one block of coded bits,
the block of coded bits comprises a set of bits associated with each of the plurality of TRPs, and
each set of bits indicates the activation state for at least one of the cell DTX or the cell DRX configured for the corresponding TRP.

23. The apparatus of claim 17, wherein:
the plurality of TRPs, including the apparatus, are associated with a plurality of serving cells,
the indication comprises a plurality of blocks of coded bits,
each block of coded bits is associated with one serving cell of the plurality of serving cells;
each block of coded bits comprises a set of bits associated with each TRP of the plurality of TRPs associated with the serving cell associated with the corresponding block; and
each set of bits indicates the activation state for at least one of the cell DTX or the cell DRX configured for the corresponding TRP.

24. The apparatus of claim 17, wherein:
the indication comprises a plurality of blocks of coded bits,
each block of coded bits comprises a set of bits associated with one TRP of the plurality of TRPs, including the apparatus, and
each set of bits indicates the activation state for at least one of the cell DTX or the cell DRX configured for the corresponding TRP.

25. The apparatus of claim 17, wherein to send the indication the one or more processors are configured to cause the apparatus to send the indication via downlink control information (DCI).

26. An apparatus configured for wireless communications, comprising:
one or more memories; and
one or more processors coupled to the one or more memories, the one or more processors being configured to cause the apparatus to:
send, to a user equipment (UE) via a first transmission reception point (TRP) of the apparatus, a first indication indicating to change a first activation state for at least one of cell discontinuous transmission (DTX) or cell discontinuous reception (DRX) for the first TRP;
send, to the UE via a second TRP of the apparatus, a second indication indicating to change a second activation state for at least one of the cell DTX or the cell DRX for the second TRP;
based at least in part on the first indication, change the first activation state for at least one of the cell DTX or the cell DRX for the first TRP; and
based at least in part on the second indication, change the second activation state for at least one of the cell DTX or the cell DRX for the second TRP.

27. The apparatus of claim 26, wherein to send, to the UE, the first indication, the one or more processors are configured to cause the apparatus to send the first indication via downlink control information (DCI).

28. The apparatus of claim 26, wherein to send, to the UE, the second indication, the one or more processors are configured to cause the apparatus to send the second indication via downlink control information (DCI).

29. The apparatus of claim 26, wherein to send, to the UE, the first indication, the one or more processors are configured to cause the apparatus to send the first indication via radio resource control (RRC) signaling.

30. The apparatus of claim 26, wherein to send, to the UE, the second indication, the one or more processors are configured to cause the apparatus to send the second indication via radio resource control (RRC) signaling.
